(19) United States
(12) Patent Application Publication
(10) Pub. No.: US 2025/0260911 A1
(43) Pub. Date: Aug. 14, 2025

(54) SYSTEM

(71) Applicant: SONY SEMICONDUCTOR SOLUTIONS CORPORATION, KANAGAWA (JP)

(72) Inventors: MASAKI SAKAKIBARA, KANAGAWA (JP); YORITO SAKANO, KANAGAWA (JP); TAKAHIRO TOYOSHIMA, KANAGAWA (JP); TAKAYA YAMANAKA, KANAGAWA (JP)

(21) Appl. No.: 18/849,405

(22) PCT Filed: Mar. 15, 2023
(86) PCT No.: PCT/JP2023/010081

§ 371 Date: Sep. 20, 2024

(30) Foreign Application Priority Data
Mar. 29, 2022 (JP) 2022-054170

(51) Int. Cl. H04N 25/771; H04N 25/616

(52) U.S. Cl. CPC H04N 25/771; H04N 25/616

(57) ABSTRACT

A system includes: a light source that emits light to a subject; a photodetection element that receives the light from the light source; and a light source control part that controls a light emission timing of the light source. The photodetection element includes: a photoelectric conversion part that generates by photoelectric conversion a charge pursuant to an amount of the received light; a transfer part that transfers the charge generated by the photoelectric conversion part; and a charge accumulation part that accumulates the charge transferred by the transfer part. The charge accumulated in the charge accumulation part is read at least twice or more nondestructively without being initialized, over a plurality of frames.

### TECHNICAL FIELD

Embodiments according to the present disclosure relate to a system.

### BACKGROUND ART

In recent years, image sensors such as a complementary metal oxide semiconductor (CMOS) image sensor and the like have become widespread and have been utilized in various fields. As a technique related to an image sensor, for example, a technique disclosed in Patent Document 1 has been known.

Furthermore, there is a case where an image is detected in such a manner that an image sensor receives light emitted from a light source and reflected from a subject.

### CITATION LIST

### Patent Document

Patent Document 1: Japanese Patent Application Laid-Open No. 2020-48018

### SUMMARY OF THE INVENTION

### Problems to be Solved by the Invention

However, since the image sensor receives, as background light, light other than the light source, it is difficult to appropriately acquire a signal component of the light source light from a pixel signal.

Therefore, the present disclosure provides a system capable of acquiring a more appropriate image.

### Solutions to Problems

In order to solve the problem described above, according to the present disclosure,
a system is provided, which includes:
a light source that emits light to a subject;
a photodetection element that receives the light from the light source; and
a light source control part that controls a light emission timing of the light source,
in which
the photodetection element includes:
   a photoelectric conversion part that generates by photoelectric conversion a charge pursuant to an amount of the received light;
   a transfer part that transfers the charge generated by the photoelectric conversion part; and
   a charge accumulation part that accumulates the charge transferred by the transfer part, and
the charge accumulated in the charge accumulation part is read at least twice or more nondestructively without being initialized, over a plurality of frames.

The system according to claim 1, wherein
the photodetection element further includes a first initialization part that initializes a charge in the photoelectric conversion part, and
a plurality of the first initialization parts of all pixels each stop initializing a charge in a corresponding one of a plurality of the photoelectric conversion parts of all the pixels in a predetermined period, so that the photoelectric conversion parts substantially concurrently accumulate charges.

The light source control part may control the light emission timing of the light source such that the light source emits the light in the predetermined period.

A plurality of the transfer parts each may transfer the charge accumulated in a corresponding one of the plurality of the photoelectric conversion parts to a corresponding one of a plurality of the charge accumulation parts in the predetermined period.

The photodetection element may further include a read part that reads the charge accumulated in the charge accumulation part, and
the read part may read the charge accumulated in the charge accumulation part, nondestructively without initialization for every single pixel or a plurality of the read parts may respectively read charges accumulated in a plurality of the charge accumulation parts, nondestructively without initialization for every multiple pixels.

The photodetection element may further include a second initialization part that initializes the charge accumulated in the charge accumulation part over the plurality of frames.

In a plurality of pixels, a plurality of the second initialization parts each may initialize a charge in a corresponding one of a plurality of the charge accumulation parts such that the charges are accumulated in the charge accumulation parts for substantially a same period of time.

In a case where the charge accumulated in the charge accumulation part is read nondestructively without being initialized for every single pixel, the second initialization part may initialize the charge in the charge accumulation part for every single pixel, and
in a case where charges accumulated in a plurality of the charge accumulation parts are read nondestructively without being initialized for every multiple pixels, a plurality of the second initialization parts each may initialize the charge in a corresponding one of the plurality of the charge accumulation parts for every multiple pixels.

The charge accumulated in the charge accumulation part may be read four times over the plurality of frames,
a first read may be performed during initialization of the charge in the charge accumulation part or after the initialization of the charge in the charge accumulation part,
a second read after the first read may be performed after a first frame in which no charge is accumulated in the photoelectric conversion part,
a third read after the second read may be performed after a second frame in which a charge is accumulated in the photoelectric conversion part and the light source emits no light, and
a fourth read after the third read may be performed after a third frame in which a charge is accumulated in the photoelectric conversion part and the light source emits light.

The system may further include
a calculation part that calculates at least one of a signal component of the light emitted from the light source or a signal component of background light, on the basis of signals pursuant to the charges respectively read by the first read, the second read, the third read, and the fourth read.

The photodetection element may further include a reference voltage generation part that generates a reference voltage for a read part that reads the charge accumulated in the charge accumulation part, before the read part reads the charge.

The photodetection element may further include a pixel array part including a plurality of pixels that are arranged, and
the reference voltage generation part may include a dummy pixel that is provided in the pixel array part.

The reference voltage generation part may include a reference voltage node to which the reference voltage is supplied.

The system may include
a plurality of the reference voltage generation parts shared among a plurality of pixels,
the plurality of the reference voltage generation parts being electrically connected on at least one of an input side of the reference voltage or an output side of the reference voltage.

The photodetection element may further include:
an additional capacitance part that adds a capacitance to the charge accumulation part; and
a switch part that switches addition of the capacitance by the additional capacitance part.

The light source may emit infrared (IR) light.

### BRIEF DESCRIPTION OF DRAWINGS

FIG. 1 is a diagram illustrating an exemplary configuration of a system according to a first embodiment.

FIG. 2 is a diagram illustrating an exemplary configuration of a solid-state imaging device according to the first embodiment.

FIG. 3 is a circuit diagram illustrating an exemplary configuration of a pixel in the solid-state imaging device according to the first embodiment.

FIG. 4 is a diagram illustrating exemplary configurations of a pixel and an ADC according to the first embodiment.

FIG. 5 is a diagram illustrating exemplary operation of the system according to the first embodiment.

FIG. 6 is a diagram illustrating an exemplary signal component in a read according to the first embodiment.

FIG. 7A is a timing chart illustrating exemplary operation of the solid-state imaging device according to the first embodiment.

FIG. 7B is a timing chart illustrating exemplary operation of the solid-state imaging device according to the first embodiment.

FIG. 7C is a timing chart illustrating exemplary operation of the solid-state imaging device according to the first embodiment.

FIG. 7D is a timing chart illustrating exemplary operation of the solid-state imaging device according to the first embodiment.

FIG. 7E is a timing chart illustrating exemplary operation of the solid-state imaging device according to the first embodiment.

FIG. 7F is a timing chart illustrating exemplary operation of the solid-state imaging device according to the first embodiment.

FIG. 7G is a timing chart illustrating exemplary operation of the solid-state imaging device according to the first embodiment.

FIG. 8A is a timing chart illustrating exemplary operation of the solid-state imaging device according to the first embodiment.

FIG. 8B is a timing chart illustrating exemplary operation of the solid-state imaging device according to the first embodiment.

FIG. 8C is a timing chart illustrating exemplary operation of the solid-state imaging device according to the first embodiment.

FIG. 8D is a timing chart illustrating exemplary operation of the solid-state imaging device according to the first embodiment.

FIG. 9 is a diagram illustrating an exemplary configuration of a reference voltage generation circuit according to a second embodiment.

FIG. 10 is a diagram illustrating an exemplary configuration of a reference voltage generation circuit according to a third embodiment.

FIG. 11 is a diagram illustrating exemplary configurations of a reference voltage generation circuit and its surroundings according to a fourth embodiment.

FIG. 12 is a diagram illustrating exemplary configurations of a reference voltage generation circuit and its surroundings according to a fifth embodiment.

FIG. 13 is a diagram illustrating exemplary configurations of a reference voltage generation circuit and its surroundings according to a sixth embodiment.

FIG. 14 is a timing chart illustrating exemplary operation of a solid-state imaging device according to a seventh embodiment.

FIG. 15 is a timing chart illustrating exemplary operation of a solid-state imaging device according to an eighth embodiment.

FIG. 16 is a diagram illustrating an exemplary signal component in a read according to a ninth embodiment.

FIG. 17 is a diagram illustrating an exemplary signal component in a read according to a tenth embodiment.

FIG. 18A is a timing chart illustrating exemplary operation of a solid-state imaging device according to an eleventh embodiment.

FIG. 18B is a timing chart illustrating exemplary operation of the solid-state imaging device according to the eleventh embodiment.

FIG. 19 is a sectional view illustrating an exemplary configuration of a solid-state imaging device according to a twelfth embodiment.

FIG. 20 is a sectional view illustrating an exemplary configuration of a solid-state imaging device according to a thirteenth embodiment.

FIG. 21 is a sectional view illustrating an exemplary configuration of a solid-state imaging device according to a fourteenth embodiment.

FIG. 22 is a block diagram illustrating an exemplary schematic configuration of a vehicle control system.

FIG. 23 is an explanatory diagram illustrating exemplary installation positions of an outside-vehicle information detecting section and an imaging section.

### MODE FOR CARRYING OUT THE INVENTION

Embodiments of a system will be described below with reference to the drawings. Although principal constituents of the system are mainly described below, the system may have constituents and functions that are not illustrated or described. The following description does not exclude constituents and functions that are not illustrated or described.

### First Embodiment

### (Example of System)

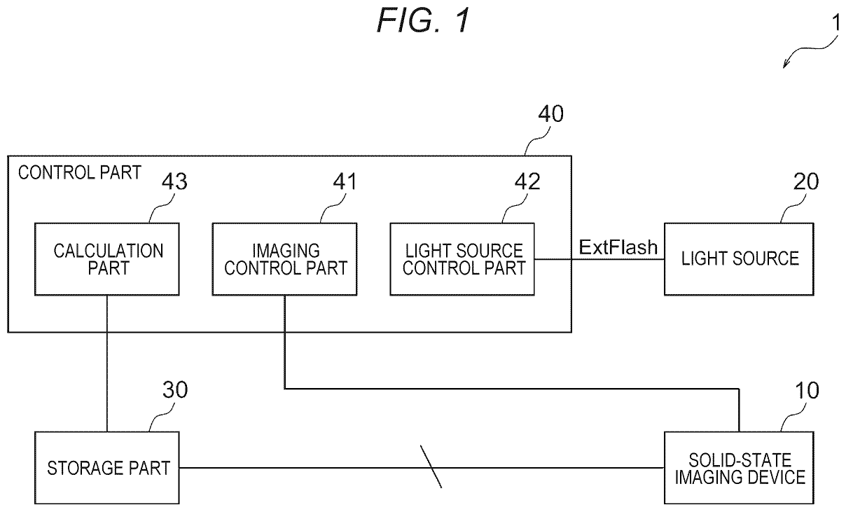

FIG. 1 is a diagram illustrating an exemplary configuration of a system 1 to which the technology according to the present disclosure is applied.

The system 1 includes a solid-state imaging device 10, a light source 20, a storage part 30, and a control part 40. Note that the solid-state imaging device 10 is occasionally referred to as a photodetection element or an imaging element.

The solid-state imaging device 10 illustrated in FIG. 1 is configured as an image sensor using, for example, a complementary metal oxide semiconductor (CMOS) (a CMOS image sensor) or the like. The solid-state imaging device 10 captures incident light (image light) from a subject through an optical lens system (not illustrated), converts an amount of the incident light forming an image on an imaging surface into an electric signal on a pixel basis, and outputs the electric signal as a pixel signal.

The light source (a light emission part) 20 emits light to the subject (not illustrated). More specifically, the light source 20 emits, for example, infrared (IR) light. Note that light to be emitted from the light source 20 is not limited to IR light.

Furthermore, the solid-state imaging device 10 receives light from the light source 20 (light source light). More specifically, the solid-state imaging device 10 receives reflected light which is the light source light reflected from the subject. The solid-state imaging device 10 also receives background light in addition to the light source light. The background light is light resulting from an ambient environment, such as sunlight or the like.

The storage part 30 stores a pixel signal output from the solid-state imaging device 10. The storage part 30 is, for example, a frame memory.

The control part 40 performs control and makes a calculation in the system 1. The control part 40 includes an imaging control part 41, a light source control part 42, and a calculation part 43.

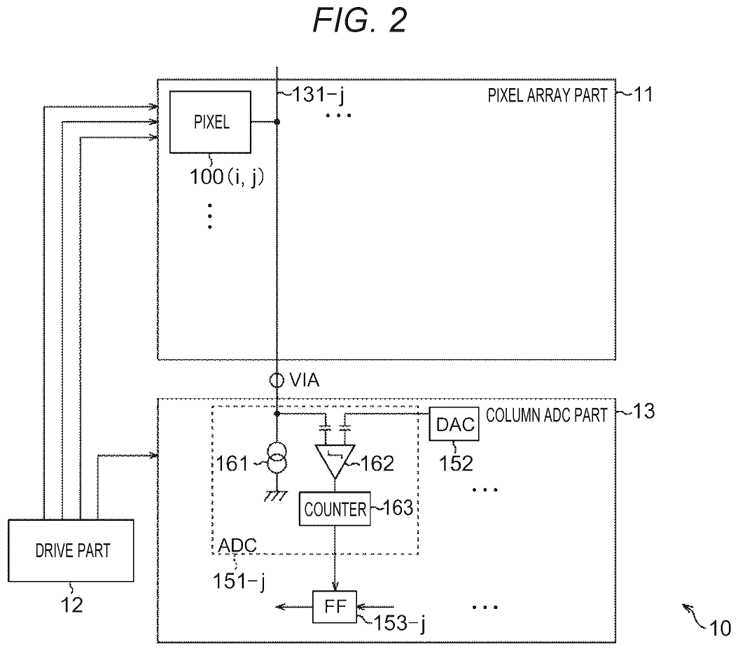

The imaging control part 41 controls the solid-state imaging device 10. The imaging control part 41 sends, for example, information regarding operation of the solid-state imaging device 10 to a drive part 12 (see FIG. 2) of the solid-state imaging device 10.

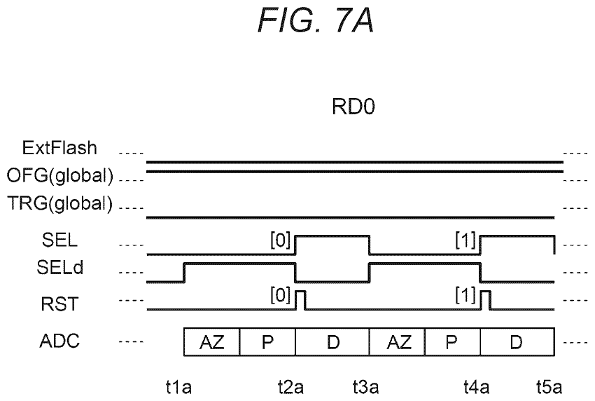

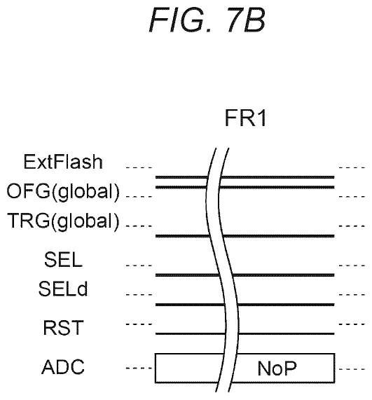

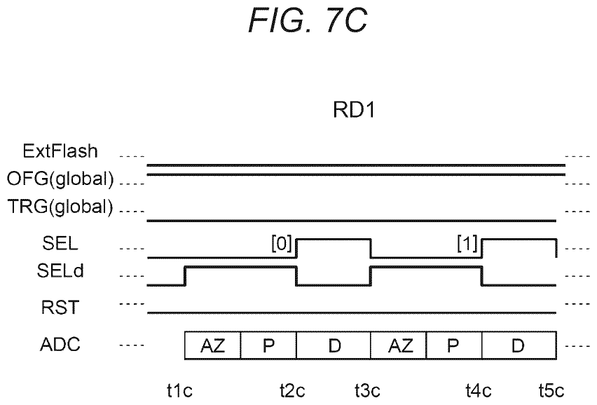

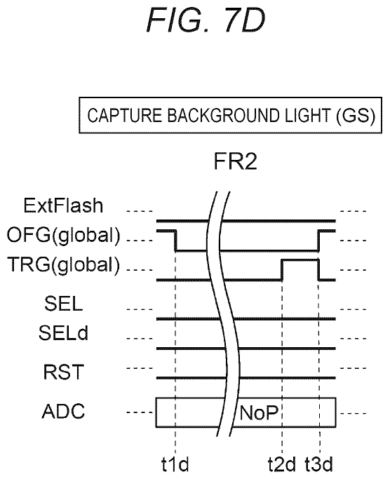

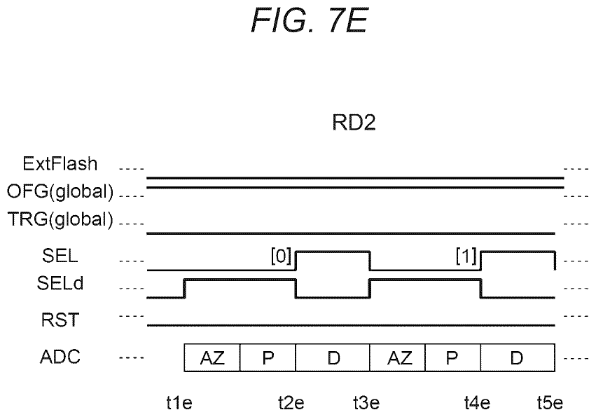

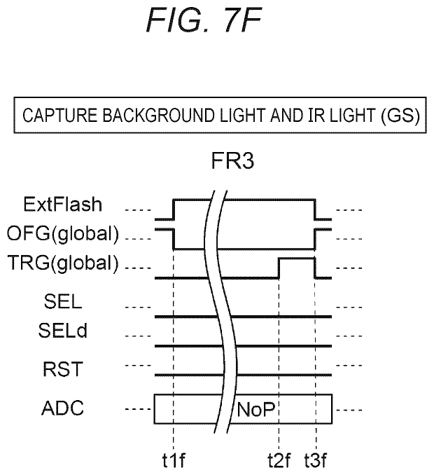

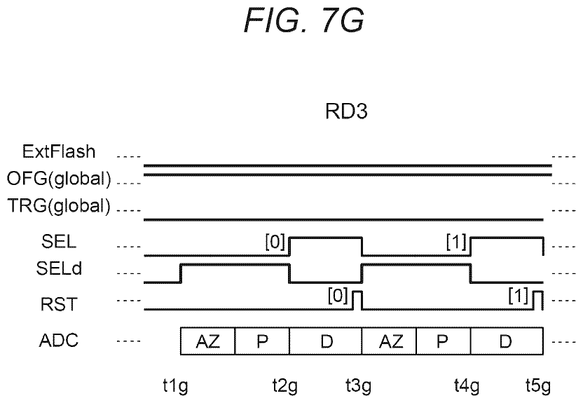

The light source control part 42 controls a light emission timing of the light source 20. The light source control part 42 sends, for example, information regarding operation of the light source 20 (a drive signal ExtFlash) to the light source 20. Note that the details of the information regarding the operation of the light source 20 will be described later with reference to FIGS. 7A to 7G.

The imaging control part 41 and the light source control part 42 are provided to more appropriately control a drive timing of the solid-state imaging device 10 and a drive timing of the light source 20.

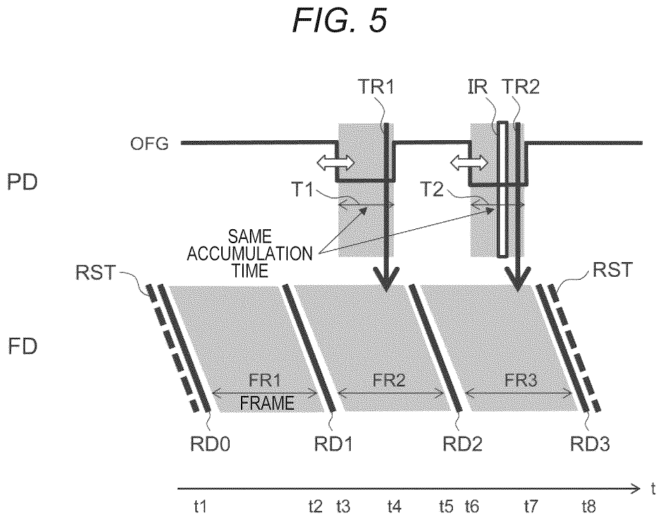

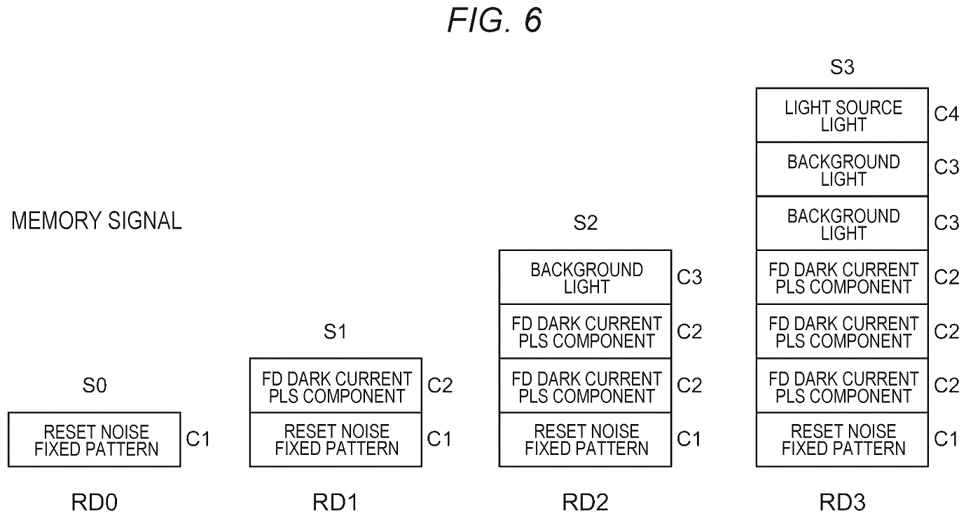

The calculation part 43 calculates a signal component from the pixel signal stored in the storage part 30. Note that the details of the calculation by the calculation part 43 will be described later with reference to FIGS. 5 and 6.

The solid-state imaging device 10, the light source 20, the storage part 30, and the control part 40 may be mounted on different chips (substrates), respectively. Alternatively, all the solid-state imaging device 10, the light source 20, the storage part 30, and the control part 40 may be mounted on a single chip. Still alternatively, some of the solid-state imaging device 10, the light source 20, the storage part 30, and the control part 40 may be mounted on a single chip.

### (Exemplary Configuration of Solid-State Imaging Device)

FIG. 2 is a diagram illustrating an exemplary configuration of the solid-state imaging device 10 to which the technology according to the present disclosure is applied.

In FIG. 2, the solid-state imaging device 10 includes a pixel array part 11, the drive part 12, and a column ADC part 13.

The pixel array part 11 includes a plurality of pixels 100 that are arranged two-dimensionally (in a matrix form). The pixels 100 each include a photodiode as a photoelectric conversion element (a photoelectric conversion part), and a plurality of pixel transistors. For example, the pixel transistors include a transfer transistor (TRG), a reset transistor (RST), an amplification transistor (AMP), and a select transistor (SEL).

Note that in the following description, the pixels 100 arranged two-dimensionally (“i” rows×“j” columns) in the pixel array part 11 are also referred to as pixels 100(i, j).

The drive part 12 is constituted of, for example, a shift register or the like. The drive part 12 selects a predetermined pixel drive line and applies a drive signal (a pulse signal) to the selected pixel drive line to drive the pixels 100 on a row basis. That is, the drive part 12 selects and scans the pixels 100 arranged in the pixel array part 11 sequentially and vertically on a row basis, and supplies a pixel signal pursuant to a signal charge (a charge) generated in accordance with an amount of received light at the photodiode of each pixel 100, to the column ADC part 13 through a vertical signal line 131.

The column ADC part 13 includes analog-to-digital converters (ADCs) 151-j provided for the respective columns of the pixels 100(i,j) arranged two-dimensionally in the pixel array part 11. The ADCs 151-j each include a constant current circuit 161, a comparator 162, and a counter 163.

The constant current circuit 161 is connected to one end of the vertical signal line 131-j connected to the pixels 100(i,j). The comparator 162 compares a signal voltage (Vx) input thereto through the vertical signal line 131-j with a reference voltage (Vref) of a ramp wave (Ramp) from a digital-to-analog converter (DAC) 152, and outputs an output signal at a level pursuant to the comparison result to the counter 163.

The counter 163 makes a count on the basis of the output signal from the comparator 162, and outputs the count value to an FF circuit 153-j. The count values held by the FF circuits 153-j are sequentially transferred to a horizontal output line (by shifting digital values), and are obtained as imaging signals. For example, here, a correlated double sampling (CDS) operation is performed by reading reset components and signal components of the pixels 100(i,j) in succession, and counting and subtracting the read reset components and signal components. Note that the counter may serve as an up/down counter to make a CDS calculation.

Note that the solid-state imaging device 10 can employ a stack structure (a multilayer structure such as a two-layer structure) in which the pixel array part 11 and the column ADC part 13 are stacked and a signal line is connected between the pixel array part 11 and the column ADC part 13 through a via (VIA). Furthermore, the solid-state imaging device 10 can be, for example, an image sensor of a back surface illumination type.

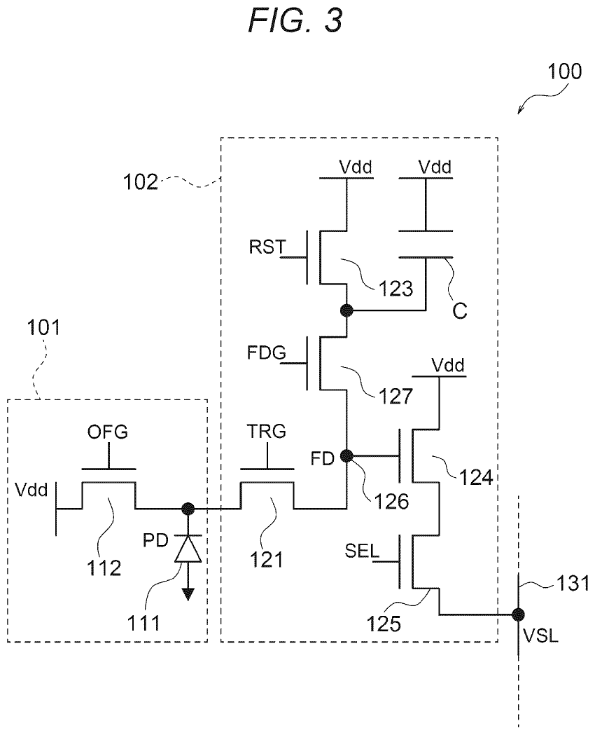

FIG. 3 illustrates an exemplary configuration of one of the pixels 100 arranged two-dimensionally in the pixel array part 11 illustrated in FIG. 1.

In FIG. 3, the pixel 100 includes a photodiode part 101 and an analog memory part 102. The photodiode part 101 includes a photodiode (PD) 111 and a reset transistor (OFG) 112. The analog memory part 102 includes a transfer transistor (TRG) 121, a reset transistor (RST) 123, an amplification transistor (AMP) 124, a select transistor (SEL) 125, a gain control transistor (FDG) 127, and a capacitor C.

The photodiode (the photoelectric conversion part) 111 has, for example, a photoelectric conversion region of a pn junction, and generates and accumulates a signal charge (a charge) pursuant to an amount of received light. The photodiode 111 includes an anode electrode that is provided at one end thereof and is grounded, and a cathode electrode that is provided at the other end thereof and is connected to a source of the transfer transistor 121.

The reset transistor (a first initialization part) 112 is connected between the photodiode 111 and a power supply part. The reset transistor 112 includes a gate to which a drive signal OFG from the drive part 12 (FIG. 2) is applied. When this drive signal OFG is brought into an active state, a reset gate of the reset transistor 112 is brought into a conductive state, and the photodiode 111 is reset.

The transfer transistor 121 includes a drain that is connected to a source of the reset transistor 123 and a gate of the amplification transistor 124, and this connection point constitutes a floating diffusion (FD) 126 as a floating diffusion region.

The transfer transistor (a transfer part) 121 is connected between the photodiode 111 and the floating diffusion 126. The transfer transistor 121 includes a gate to which a drive signal TRG from the drive part 12 (FIG. 2) is applied. When this drive signal TRG is brought into an active state, a transfer gate of the transfer transistor 121 is brought into a conductive state, and the charge accumulated in the photodiode 111 is transferred from the photodiode part 101 side to the analog memory part 102 side.

The floating diffusion 126 holds the charge transferred by the transfer transistor 121. Furthermore, the floating diffusion 126 outputs a voltage signal subjected to charge-to-voltage conversion, to (the gate of) the amplification transistor 124.

The reset transistor 123 is connected between the floating diffusion 126 and the power supply part. More specifically, the reset transistor 123 is connected to the power supply part via the gain control transistor 127. The reset transistor 123 includes a gate to which a drive signal RST from the drive part 12 (FIG. 2) is applied. When this drive signal RST is brought into an active state, a reset gate of the reset transistor 123 is brought into a conductive state. In a case where the gain control transistor 127 becomes conductive, the floating diffusion 126 is reset.

The amplification transistor 124 includes the gate connected to the floating diffusion 126 and a drain connected to the power supply part, and thus serves as an input part of a source follower circuit corresponding to a read circuit for the voltage signal held at the floating diffusion 126. That is, the amplification transistor 124 includes a source that is connected to the vertical signal line 131 via the select transistor 125, and thus constitutes a source follower circuit in cooperation with the constant current circuit 161 (FIG. 2) connected to one end of the vertical signal line 131.

The select transistor 125 is connected between the source of the amplification transistor 124 and the vertical signal line 131. The select transistor 125 includes a gate to which a drive signal SEL from the drive part 12 (FIG. 2) is applied. When this drive signal SEL is brought into an active state, the select transistor 125 is brought into a conductive state, and the pixel 100 is brought into a selected state. Therefore, a read signal (a pixel signal) output from the amplification transistor 124 is output to the vertical signal line 131 via the select transistor 125.

The gain control transistor (a switch part) 127 is connected between the transfer transistor 121 and the reset transistor 123. The gain control transistor 127 includes a gate to which a drive signal FDG from the drive part 12 (FIG. 2) is applied. When the drive signal FDG is brought into an active state, a gain control gate of the gain control transistor 127 is brought into a conductive state, and the floating diffusion 126 is electrically connected to the capacitor (an additional capacitance part) C that adds a capacitance. Therefore, it is possible to control the sensitivity of signal detection.

In each pixel 100 configured as described above, while the drive signals OFG, TRG, RST, and FDG applied to the gates of the reset transistor 112, transfer transistor 121, reset transistor 123, and gain control transistor 127 are controlled collectively in a sensor (on a sensor basis), the drive signal SEL applied to the gate of the select transistor 125 is controlled on a line basis (a row basis), so that the charge accumulated in the photodiode 111 through an exposure by a global shutter method is transferred and held at the floating diffusion 126, and (the pixel signal pursuant to) the charge held at the floating diffusion 126 is nondestructively read.

### (Configurations of Reference Voltage Generation Circuit and ADC)

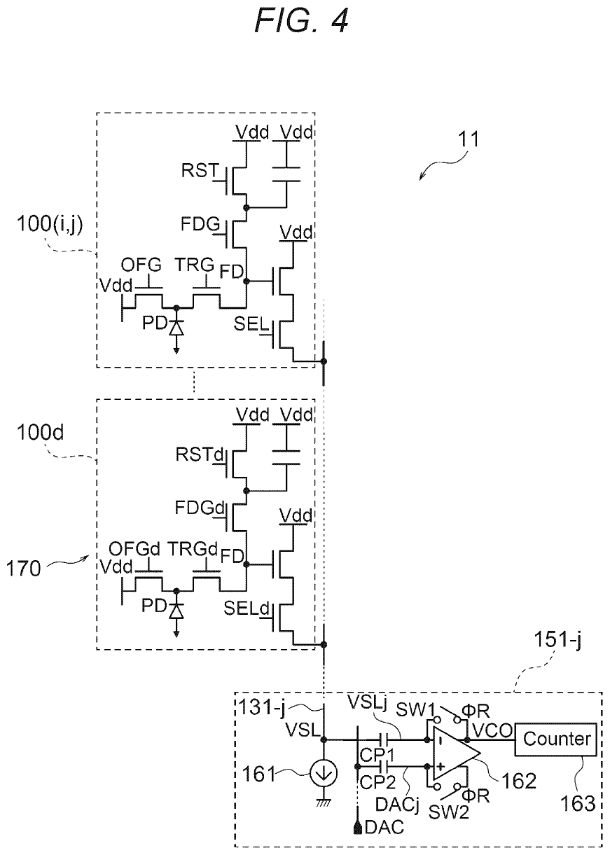

FIG. 4 is a diagram illustrating exemplary configurations the pixels 100 and ADC 131-j according to the first embodiment.

The solid-state imaging device 10 further includes a reference voltage generation circuit 170.

The reference voltage generation circuit 170 generates a reference voltage for a read part that reads the charge accumulated in the floating diffusion 126, before the read part reads the charge. The read part includes the ADC 151-j and the like. The reference voltage is a reference voltage in performing auto-zeroing on the ADC 151-j. The reference voltage generation circuit is electrically connected to the constant current circuit 161 through the vertical signal line 131-j, and the reference voltage is read by a source follower. As will be described later with reference to FIG. 5, the reference voltage generation circuit 170 that generates a reference signal for correlated double sampling is provided since the charge in the floating diffusion 126 is superimposed without being reset.

In the example illustrated in FIG. 4, the reference voltage generation circuit 170 is, for example, a dummy pixel 100d that is shielded from light. The dummy pixel 100d is provided in the pixel array part 11.

The dummy pixel 100d has a configuration that is substantially similar to the configuration of each pixel 100(i,j) in the main body. The dummy pixel 100d has a configuration that is substantially similar to the configuration of each pixel 100(i,j). The dummy pixel 100d includes a reset transistor 112, and a drive signal OFGd from the drive part 12 is applied to a gate of the reset transistor 112. The dummy pixel 100d includes a transfer transistor 121, and a drive signal TRGd from the drive part 12 is applied to a gate of the transfer transistor 121. The dummy pixel 100d includes a reset transistor 123, and a drive signal RSTd from the drive part 12 is applied to a gate of the reset transistor 123. The dummy pixel 100d includes a select transistor 125, and a drive signal SELd from the drive part 12 is applied to a gate of the select transistor 125. The dummy pixel 100d includes a gain control transistor 127, and a drive signal FDGd from the drive part 12 is applied to a gate of the gain control transistor 127.

Furthermore, the ADC 151-j further includes switches SW1 and SW2 and capacitors CP1 and CP2. The switches SW1 and SW2 and the capacitors CP1 and CP2 each perform auto-zeroing.

The switch SW1 is connected between a first input part (“−” in FIG. 4) of the comparator 162 and a first output part of the comparator 162. A drive signal OR from the drive part 12 is input to the switch SW1.

The switch SW2 is connected between a second input part (“+” in FIG. 4) of the comparator 162 and a second output part of the comparator 162. The drive signal φR from the drive part 12 is input to the switch SW2.

The capacitor CP1 is connected between the first input part of the comparator 162 and the vertical signal line 131-j. When the switch SW1 is turned on, an output signal from the comparator 162 is fed back to the first input part of the comparator 162. Thereafter, when the switch SW1 is turned off, the capacitor CP1 holds a voltage VSLj from the vertical signal line 131-j. Therefore, the voltage VSLj is input to the first input part of the comparator 162.

The capacitor CP2 is connected between the second input part of the comparator 162 and the DAC 152. When the switch SW2 is turned on, an output signal from the comparator 162 is fed back to the second input part of the comparator 162. Thereafter, when the switch SW2 is turned off, the capacitor CP2 holds a voltage DACj from the DAC 152. Therefore, the voltage DACj is input to the second input part of the comparator 162.

### (Read Operation and Calculation of Signal Component)

FIG. 5 is a diagram illustrating exemplary operation of the system 1 according to the first embodiment. FIG. 6 is a diagram illustrating exemplary signal components in reads RD0 to RD3 according to the first embodiment.

In FIG. 5, the horizontal axis indicates a time t. In FIG. 5, the upper stage illustrates a timing of the drive signal OFG and a timing of an exposure to the photodiode 111. In FIG. 5, the lower stage illustrates a read (RD0 to RD3) of a signal based on a charge accumulated in the floating diffusion 126 and a timing of a reset (RST).

As illustrated in FIG. 5, a charge accumulated in the floating diffusion 126 is read at least twice or more nondestructively without being initialized (reset), over a plurality of frames. In the example illustrated in FIG. 5, the charge accumulated in the floating diffusion 126 is read four times (RD0 to RD3) over a plurality of frames FR1 to FR3.

Note that the read part reads the charge accumulated in the floating diffusion 126. More specifically, the read part reads the charge accumulated in the floating diffusion 126, nondestructively without initialization for every single pixel 100 (line sequential) or the read parts respectively read the charges accumulated in the floating diffusions 126, nondestructively without initialization for every multiple pixels 100 (band sequential). Furthermore, the read part reads the pixel signal based on the charge accumulated in the floating diffusion 126.

Furthermore, the reset transistor (a second initialization part) 123 initializes the charge accumulated in the floating diffusion 126 over the plurality of frames.

In a case where the read part reads the charge accumulated in the floating diffusion 126, nondestructively without initialization for every single pixel 100 (line sequential), the reset transistor 123 and the gain control transistor 127 initialize the charge in the floating diffusion 126 for every single pixel 100 (line sequential). On the other hand, in a case where the read parts respectively read the charges accumulated in the floating diffusions 126, nondestructively without initialization for every multiple pixels 100 (band sequential), the reset transistors 123 and the gain control transistors 127 respectively initialize the charges in the floating diffusions 126 for every multiple pixels 100 (band sequential).

Although exposures to the photodiodes 111 are substantially simultaneously performed in all the pixels, the reads of the charges are performed at different timings for each pixel. In the example illustrated in FIG. 5, each of the reads RD0 to RD3 is inclined with respect to the vertical direction of the paper surface of FIG. 5. Furthermore, the light emitted from the light source 20 is received at all the pixels. By driving the system 1 illustrated in FIG. 5, it is possible to obtain pseudo global shutter images of light source light and background light, using a rolling read method.

Furthermore, in the plurality of pixels 100, the reset transistors 123 respectively initialize the charges in the floating diffusions 126 such that the charges are accumulated in the floating diffusions 126 for substantially the same period of time. That is, the reset transistors 123 perform initialization on the floating diffusions 126 at substantially the same speed as a speed of the reads by the read parts. Therefore, it is possible to suppress a time difference in background light among the pixels 100.

In an initial state in FIG. 5, the drive signal OFG is in a High state. Accordingly, the reset transistor 112 is in an ON state.

First, at a time t1, the drive part 12 resets the charge in the floating diffusion 126 of each pixel 100, and performs a read RD0 of a signal from the pixel 100. The read RD0 is a read immediately after the reset of the floating diffusion 126.

As illustrated in FIG. 6, a pixel signal S0 read by the read RD0 is represented by Equation 1 using a signal component C1.

$$S 0 = C 1 \qquad ( Equation 1 )$$

The signal component C1 includes a reset noise (kTC noise) component and a fixed pattern noise component.

Next, at a time t2, the drive part 12 performs a read RD1 of a signal from the pixel 100. An exposure is not performed in a period from the time t1 to the time t2. Accordingly, a dark current component of the floating diffusion 126 and a charge of a parasitic light sensitivity (PLS) component are added to the floating diffusion 126.

As illustrated in FIG. 6, a pixel signal S1 read by the read RD1 is represented by Equation 2 using the signal component C1 and a signal component C2.

$$S 1 = C 1 + C 2 \qquad ( Equation 2 )$$

The signal component C2 includes the dark current component of the floating diffusion 126 and the PLS component. The signal component C2 is a signal component generated irrespective of the presence/absence of an exposure. The pixel signal S1 is different from the pixel signal S0 in a respect that the pixel signal S1 further includes the signal component C2.

Next, at a time t3, the drive signal OFG becomes low. Therefore, the reset transistor 112 is turned off. As a result, an exposure of the photodiode 111 is commenced. The photodiode 111 accumulates a charge pursuant to an amount of received light in an exposure period.

Furthermore, in the exposure period, the transfer transistor 121 is turned on to perform a transfer TR1. That is, the transfer transistor 121 transfers the charge accumulated in the photodiode 111 to the floating diffusion 126 in a predetermined period T1 (the exposure period).

Next, at a time t4, the drive signal OFG becomes high. Therefore, the reset transistor 112 is turned on. As a result, the exposure of the photodiode 111 ends.

Note that in an exposure period from the time t3 to the time t4, all the pixels 100 are substantially simultaneously exposed. That is, the reset transistors 112 of all the pixels 100 stop initializing the charges in the photodiodes 111 in the predetermined period T1 (the exposure period), so that the photodiodes 111 of all the pixels 100 substantially simultaneously accumulate charges.

Next, at a time t5, the drive part 12 performs a read RD2 of a signal from each pixel 100.

As illustrated in FIG. 6, a pixel signal S2 read by the read RD2 is represented by Equation 3 using the signal component C1, the signal component C2, and a signal component C3.

$$S 2 = C 1 + 2 \times C 2 + C 3 \qquad ( Equation 3 )$$

The signal component C3 includes a background light component. The pixel signal S2 is different from the pixel signal S1 in a respect that the pixel signal S2 further includes the signal component C2 and the signal component C3.

Here, since the time of the frame FR1 is substantially the same as the time of the frame FR2, the magnitude of the signal component C2 superimposed by the read RD1 (the pixel signal S1) is substantially the same as the magnitude of the signal component C2 superimposed by the read RD2 (the pixel signal S2).

Next, at a time t6, the drive signal OFG becomes low. Therefore, the reset transistor 112 is turned off. As a result, an exposure of the photodiode 111 is commenced. The photodiode 111 accumulates a charge pursuant to an amount of received light in an exposure period.

Furthermore, in the exposure period, the light source 20 emits IR light. The light source control part 42 controls the light emission timing of the light source 20 such that the light source 20 emits light in a predetermined period T2 (the exposure period).

Furthermore, in the exposure period, the transfer transistor 121 is turned on to perform a transfer TR2. That is, the transfer transistor 121 transfers the charge accumulated in the photodiode 111 to the floating diffusion 126 in the predetermined period T2 (the exposure period).

Next, at a time t7, the drive signal OFG becomes high. Therefore, the reset transistor 112 is turned on. As a result, the exposure of the photodiode 111 ends.

Note that in an exposure period from the time t6 to the time t7, all the pixels 100 are substantially simultaneously exposed. That is, the reset transistors 112 of all the pixels 100 stop initializing the charges in the photodiodes 111 in the predetermined period T2 (the exposure period), so that the photodiodes 111 of all the pixels 100 substantially simultaneously accumulate charges.

Next, at a time t8, the drive part 12 performs a read RD3 of a signal from each pixel 100, and resets the charge in the floating diffusion 126 of the pixel 100.

As illustrated in FIG. 6, a pixel signal S3 read by the read RD3 is represented by Equation 4 using the signal component C1, the signal component C2, the signal component C3, and a signal component C4.

$$S 3 = C 1 + 3 \times C 2 + 2 \times C 3 + C 4 \qquad ( Equation 4 )$$

The signal component C4 includes a light source light (IR light) component. The pixel signal S3 is different from the pixel signal S2 in a respect that the pixel signal S3 further includes the signal component C2, the signal component C3, and the signal component C4.

Here, since the time of the frame FR2 is substantially the same as the time of the frame FR3, the magnitude of the signal component C2 superimposed by the read RD2 (the pixel signal S2) is substantially the same as the magnitude of the signal component C2 superimposed by the read RD3 (the pixel signal S3). Likewise, since the time of the predetermined period T1 is substantially the same as the time of the predetermined period T2, the magnitude of the signal component C3 superimposed by the read RD2 (the pixel signal S2) is substantially the same as the magnitude of the signal component C3 superimposed by the read RD3 (the pixel signal S3).

As illustrated in FIG. 5, the reset transistor 123 resets the charge in the floating diffusion 126 with the drive signal RST in each of the times t1 and t8. That is, the floating diffusion 126 is not reset over the plurality of frames FR1 to FR3. Accordingly, the signal components C1 to C4 are superimposed from the read RD0 to the read RD3.

The calculation part 43 illustrated in FIG. 1 calculates the signal components C1 to C4 on the basis of Equations 1 to 4.

The calculation part 43 solves, for example, the simultaneous equations of Equations 1 to 4 to calculate the signal components C1 to C4 as four variables. That is, the calculation part 43 calculates at least one of the signal component of the light emitted from the light source 20 or the signal component of the background light, on the basis of the pixel signals pursuant to the charges respectively read by the first read RD0, second read RD1, third read RD2, and fourth read RD3. Therefore, it is possible to extract the signal components C1 to C4 one by one. It is also possible to cancel the influence of the signal components C1 and C2 as noises and to individually calculate the signal component C3 of the background light and the signal component C4 of the light source light.

### (Details of Drive)

FIGS. 7A to 7G are timing charts each illustrating exemplary operation of the solid-state imaging device 10 according to the first embodiment. FIGS. 7A, 7C, 7E, and 7G respectively illustrate the timing charts of the reads RD0, RD1, RD2, and RD3 performed on the pixels 100(0, j), 100(1, j), . . . in sequence. Note that FIGS. 7A, 7C, 7E, and 7G do not illustrate operations on and subsequent to the pixel 100(2, j).

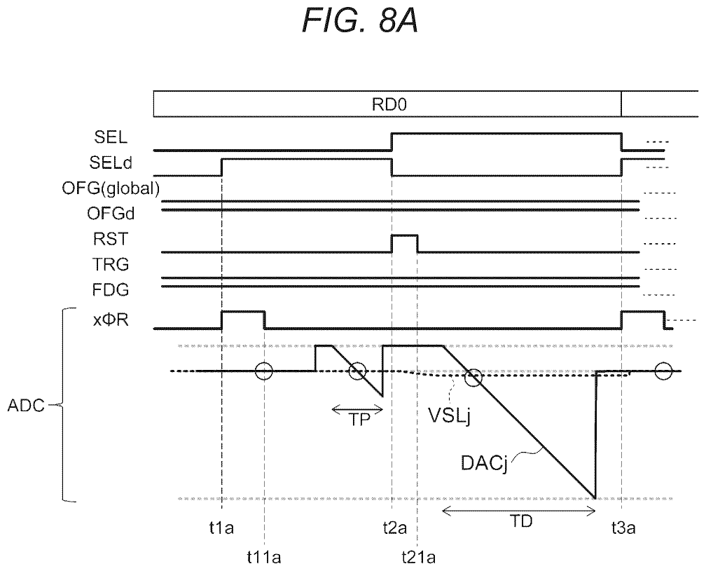

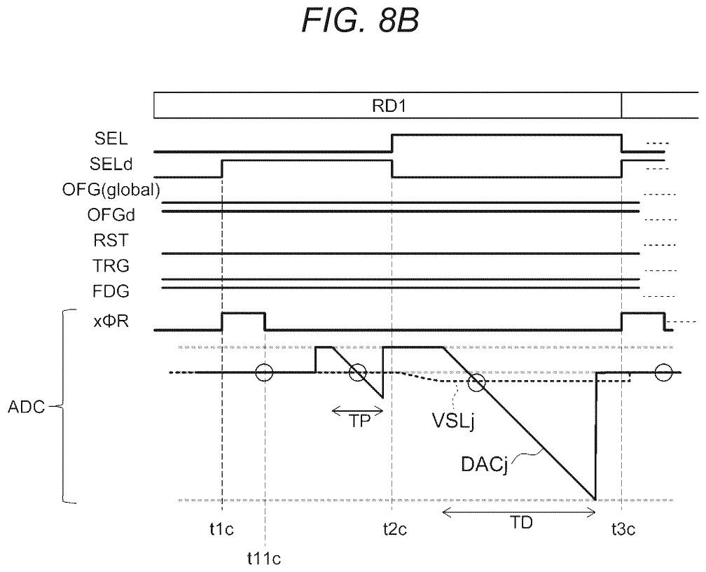

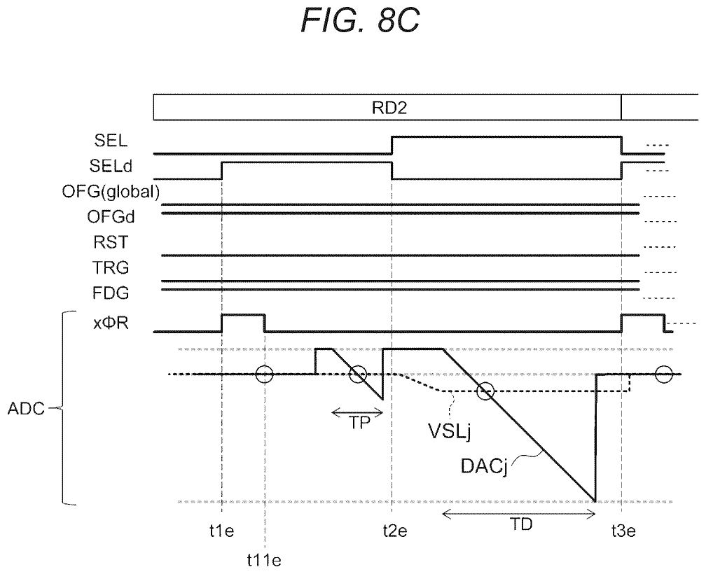

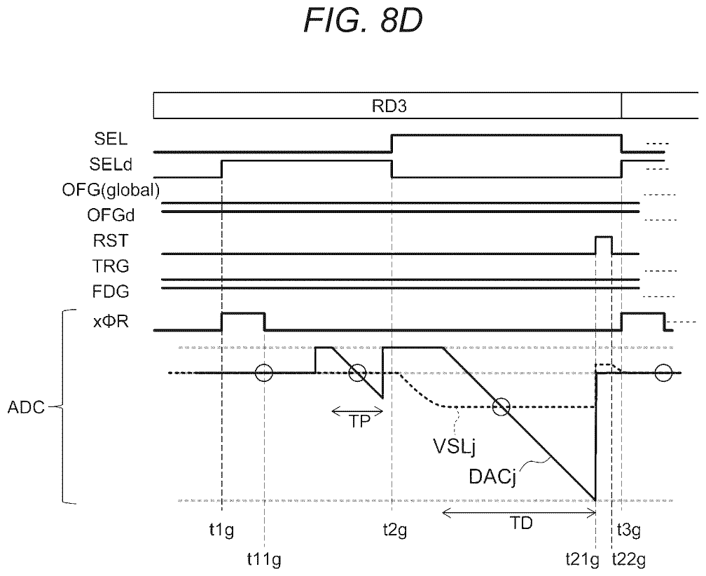

FIGS. 8A to 8D are timing charts each illustrating exemplary operation of the solid-state imaging device 10 according to the first embodiment. FIGS. 8A, 8B, 8C, and 8D respectively illustrate specific timing charts for one of the pixels 100 (e.g., the pixel 100(0, j)) in FIGS. 7A, 7C, 7E, and 7G.

Here, the operation of the ADC 151-j in FIGS. 8A to 8D will be described. In an auto-zero period (e.g., a period from a time t1a to a time t11a illustrated in FIG. 8A), an auto-zero voltage is output. In a P-phase period (a reset period) TP, the dummy pixel 100d outputs a reference voltage. In a D-phase period (a data (pixel signal) acquisition period) TD, each pixel 100 outputs a pixel voltage of a voltage pursuant to a voltage of the floating diffusion 126 at this time. In the P-phase period TP, the comparator 162 compares the reference voltage (the voltage VSLj) from the dummy pixel 100d with the reference voltage (the voltage DACj). In the D-phase period TD, the comparator 162 compares the pixel voltage (the voltage VSLj) from the pixel 100 with the reference voltage (the voltage DACj). As described above, the counter 163 makes a count on the basis of a signal from the comparator 162. Therefore, a correlated double sampling operation is performed.

Note that the reference voltage has a ramp waveform whose voltage level gradually changes in accordance with a lapse of time in the P-phase period TP and the D-phase period TD. That is, in the example illustrated in FIGS. 8A to 8D, the ADC 151-j is of a single slope type. Alternatively, the ADC 151-j may be, for example, a pipeline ADC, a cyclic ADC, a flash-type ADC, an SARDAC, a ΔΣ-type ADC, or the like.

FIG. 7A illustrates the timing chart of the read RD0.

The read (a first read) RD0 is performed during the initialization of the charge in the floating diffusion 126 or after the initialization of the charge in the floating diffusion 126.

In an initial state, the drive signal ExtFlash is in a Low state. The drive signal OFG is in a High state. Each of the drive signals TRG, SEL, SELd, and RST is in a Low state.

First, at the time t1a, the drive signal SELd becomes high. Therefore, the select transistor 125 of the dummy pixel 100d is turned on. As a result, the dummy pixel 100d is selected.

Furthermore, in a period from the time t1a to a time t2a, the ADC 151-j performs auto-zeroing and drives the P-phase period TP in the dummy pixel 100d.

Note that as illustrated in FIG. 8A, in the period from the time t1a to the time t11a, a drive signal xφR is turned on, so that auto-zeroing is performed and the voltage VSLj is held. In the period from the time t11a to the time t2a, the P-phase period TP is driven.

Next, at the time t2a, the drive signal SEL becomes high, and the drive signal SELd of the dummy pixel 100d becomes low. Therefore, the select transistor 125 of the pixel (0, j) is turned on, and the select transistor 125 of the dummy pixel 100d is turned off. As a result, the pixel 100(0, j) is selected.

Furthermore, in a period from the time t2a to a time t3a, the ADC 151-j drives the D-phase period in the pixel 100(0, j).

Note that as illustrated in FIG. 8A, in a period from the time t2a to a time t21a, the drive signal RST is turned on. Therefore, the reset transistor 123 of the pixel (0, j) is turned on. As a result, the charge in the floating diffusion 126 is reset. In a period from the time t21a to the time t3, the D-phase period TD is driven. The voltage VSLj in the D-phase period TD of the read RD0 has the voltage component corresponding to the pixel signal S0 represented by Equation 1, as described with reference to FIG. 6.

Next, at the time t3a, the drive signal SEL of the pixel (0, j) becomes low, and the drive signal SELd of the dummy pixel 100d becomes high. Therefore, therefore, the select transistor of the pixel (0, j) is turned off, and the select transistor 125 of the dummy pixel 100d is turned on. As a result, the dummy pixel 100d is selected.

Furthermore, in a period from the time t3a to a time t4a, the ADC 151-j performs auto-zeroing on the dummy pixel 100d and drives the P-phase period TP in the dummy pixel 100d.

Next, at the time t4a, the drive signal SEL becomes high, and the drive signal SELd of the dummy pixel 100d becomes low. Therefore, the select transistor 125 of the pixel 100(1, j) is turned on, and the select transistor 125 of the dummy pixel 100d is turned off. As a result, the pixel 100(1, j) is selected.

Furthermore, in a period from the time t4a to a time t5a, the ADC 151-j drives the D-phase period in the pixel 100(1, j).

Next, at the time t5a, the drive signal SEL of the pixel 100(1, j) becomes low, and the drive signal SELd of the dummy pixel 100d becomes high. Therefore, the select transistor of the pixel 100(1, j) is turned off, and the select transistor 125 of the dummy pixel 100d is turned on. As a result, the dummy pixel 100d is selected.

FIG. 7B illustrates the timing chart in the first frame FR1 between the read RD0 and the read Rd1.

The drive signal ExtFlash is in the Low state. The drive signal OFG is in the High state. Each of the drive signals TRG, SEL, SELd, and RST is in the Low state. The ADC 151-j is not operated (NoP).

FIG. 7C illustrates the timing chart of the read RD1.

The read (a second read) RD1 after the read RD0 is performed after the first frame FR1 in which no charge is accumulated in (no exposure is performed on) the photodiode 111.

The drive in the read RD1 illustrated in FIG. 7C is substantially the same as the drive in the read RD0 illustrated in FIG. 7A except the drive signal RST. In the read RD1, the drive signal RST is in the Low state. That is, the charge in the floating diffusion 126 is not reset.

As illustrated in FIG. 8B, the voltage VSLj in the D-phase period TD of the read RD1 has the voltage component corresponding to the pixel signal S1 represented by Equation 2, as described with reference to FIG. 6. This is because the charge in the floating diffusion 126 is not reset.

FIG. 7D illustrates the timing chart in the second frame FR2 between the read RD1 and the read RD2. FIG. 7D illustrates the operation in a case where the background light is captured in all the pixels at the same time (the global shutter (GS) method).

In an initial state, the drive signal ExtFlash is in the Low state. The drive signal OFG is in the High state. Each of the drive signals TRG, SEL, SELd, and RST is in the Low state.

First, at a time t1d, the drive signal OFG becomes low. Therefore, the reset transistors 112 of all the pixels 100(i,j) are turned off.

Next, at a time t2d, the drive signal TRG becomes high. Therefore, the transfer transistors 121 of all the pixels 100(i,j) are turned on.

Next, at a time t3d, the drive signal OFG becomes high. Therefore, the reset transistors 112 of all the pixels 100(i,j) are turned on. A period from the time t1d to the time t3d is an exposure period.

Furthermore, at the time t3d, the drive signal TRG becomes low. Therefore, the transfer transistors 121 of all the pixels 100(i,j) are turned off.

FIG. 7E illustrates the timing chart of the read RD2.

The read (a third read) RD2 after the read RD1 is performed after the second frame FR2 in which a charge is accumulated in (an exposure is performed on) the photodiode 111 and the light source 20 emits no light.

The drive in the read RD2 illustrated in FIG. 7E is substantially the same as the drive in the read RD1 illustrated in FIG. 7C.

As illustrated in FIG. 8C, the voltage VSLj in the D-phase period TD of the read RD2 has the voltage component corresponding to the pixel signal S2 represented by Equation 3, as described with reference to FIG. 6. This is because the charge in the floating diffusion 126 is not reset.

FIG. 7F illustrates the timing chart in the third frame FR3 between the read RD2 and the read RD3. FIG. 7F illustrates the operation in a case where the background light and the IR light (the light source light) are captured in all the pixels at the same time (the global shutter (GS) method).

In an initial state, the drive signal ExtFlash is in the Low state. The drive signal OFG is in the High state. Each of the drive signals TRG, SEL, SELd, and RST is in the Low state.

First, at a time t1f, the drive signal OFG becomes low. Therefore, the reset transistors 112 of all the pixels 100(i,j) are turned off.

Furthermore, at the time t1f, the drive signal ExtFlash becomes high. Therefore, the light source 20 emits IR light.

Next, at a time t2f, the drive signal TRG becomes high. Therefore, the transfer transistors 121 of all the pixels 100(i,j) are turned on.

Next, at a time t3f, the drive signal OFG becomes high. Therefore, the reset transistors 112 of all the pixels 100(i,j) are turned on. A period from the time t1f to the time t3f is an exposure period.

Furthermore, at the time t3f, the drive signal TRG becomes low. Therefore, the transfer transistors 121 of all the pixels 100(i,j) are turned off.

Furthermore, at the time t3f, the drive signal ExtFlash becomes low. Therefore, the light source 20 stops emitting the IR light. Note that the drive signal ExtFlash may become low at the time t2f in view of a time of extinction from the control of the light source 20.

FIG. 7G illustrates the timing chart of the read RD3.

The read (a fourth read) RD3 after the read RD2 is performed after the third frame FR3 in which a charge is accumulated in (an exposure is performed on) the photodiode 111 and the light source 20 emits light.

The drive in the read RD3 illustrated in FIG. 7G is substantially the same as the drive in the read RD0 illustrated in FIG. 7A except the drive signal RST.

As illustrated in FIG. 8D, the voltage VSLj in the D-phase period TD of the read RD3 has the voltage component corresponding to the pixel signal S3 represented by Equation 3, as described with reference to FIG. 6. This is because the charge in the floating diffusion 126 is not reset. Note that the D-phase period TD is a period to a time t21g.

Furthermore, in a period from the time t21g to a time t22g, the drive signal RST is turned on. As a result, the charge in the floating diffusion 126 is reset.

As described above, according to the first embodiment, the charge accumulated in the floating diffusion 126 is read at least twice or more nondestructively without being initialized, over the plurality of frames. Therefore, the charges are accumulated in the floating diffusions 126 for every multiple frames in accordance with the respective signal components. As a result, it is possible to calculate a signal component of IR light from a pixel signal and to acquire a more appropriate image.

Furthermore, it is possible to perform correlated double sampling and to suppress random noise.

### (Comparative Example)

There is a case where double data sampling (DDS) drive is performed, which involves holding charges transferred simultaneously to all pixels and performing signal pre-read and reset post-read. However, in this case, it is impossible to perform correlated double sampling by reset pre-read and signal post-read, so that there is a possibility that kTC noise is superimposed and image quality is deteriorated.

In view of this, according to the first embodiment, it is possible to perform a nondestructive read over a plurality of frames and to suppress an influence of noise, using a correlation between frames in a pixel signal.

### Second Embodiment

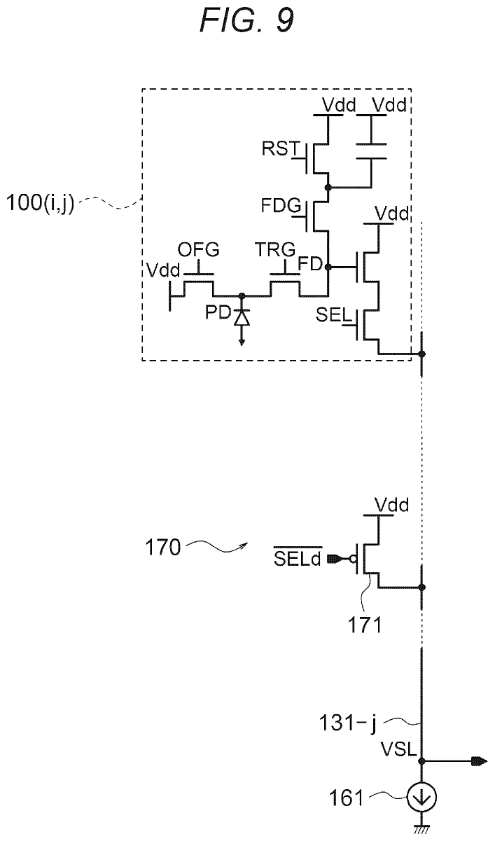

FIG. 9 is a diagram illustrating an exemplary configuration of a reference voltage generation circuit 170 according to a second embodiment. The second embodiment is different from the first embodiment in the configuration of the reference voltage generation circuit 170. Note that FIG. 9 does not illustrate a comparator 162 and the like.

The reference voltage generation circuit 170 includes a reference voltage node to which a reference voltage is supplied.

The reference voltage generation circuit 170 includes a transistor 171. The transistor 171 is connected between a vertical signal line 131-j and the reference voltage node for a voltage Vdd as a power supply part. The transistor 171 is, for example, a pMOS transistor. The transistor 171 includes a gate to which a drive signal as an inverted drive signal SELd from a drive part 12 is applied. When this drive signal is brought into an active state, the gate of a transistor 172 is brought into a conductive state, and a reference voltage is generated. Here, the reference voltage node may be any voltage rather than the voltage Vdd.

Other configurations of a system 1 according to the second embodiment may be similar to the corresponding configurations according to the first embodiment.

The configuration of the reference voltage generation circuit 170 may be changed as described in the second embodiment. Also in this case, advantageous effects similar to those of the first embodiment can be obtained.

### Third Embodiment

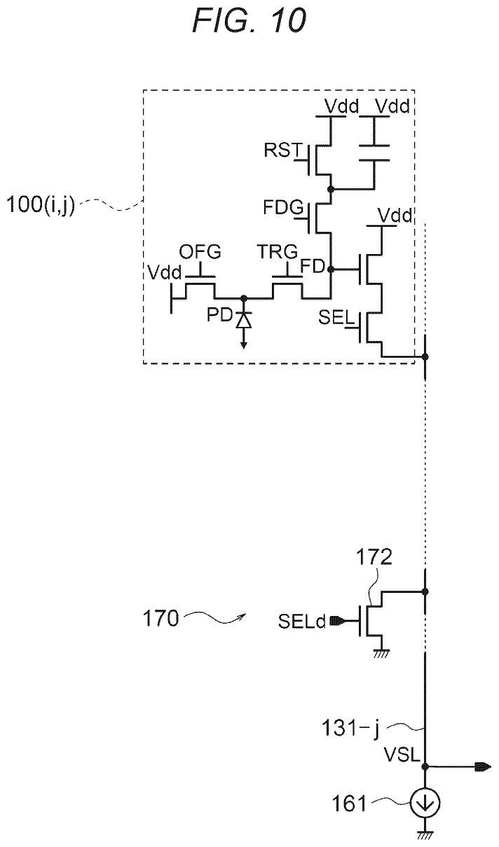

FIG. 10 is a diagram illustrating an exemplary configuration of a reference voltage generation circuit 170 according to a third embodiment. The third embodiment is different from the first embodiment in the configuration of the reference voltage generation circuit 170.

The reference voltage generation circuit 170 includes a transistor 172. The transistor 172 is connected between a vertical signal line 131-j and a reference voltage node for a ground as a power supply part. The transistor 172 is, for example, an nMOS transistor. The transistor 172 includes a gate to which a drive signal SELd from a drive part 12 is applied. When this drive signal SELd is brought into an active state, the gate of the transistor 172 is brought into a conductive state, and a reference voltage is generated. Here, the reference voltage node may be any voltage rather than the ground.

Other configurations of a system 1 according to the third embodiment may be similar to the corresponding configurations according to the first embodiment.

The configuration of the reference voltage generation circuit 170 may be changed as described in the third embodiment. Also in this case, advantageous effects similar to those of the first embodiment can be obtained.

### Fourth Embodiment

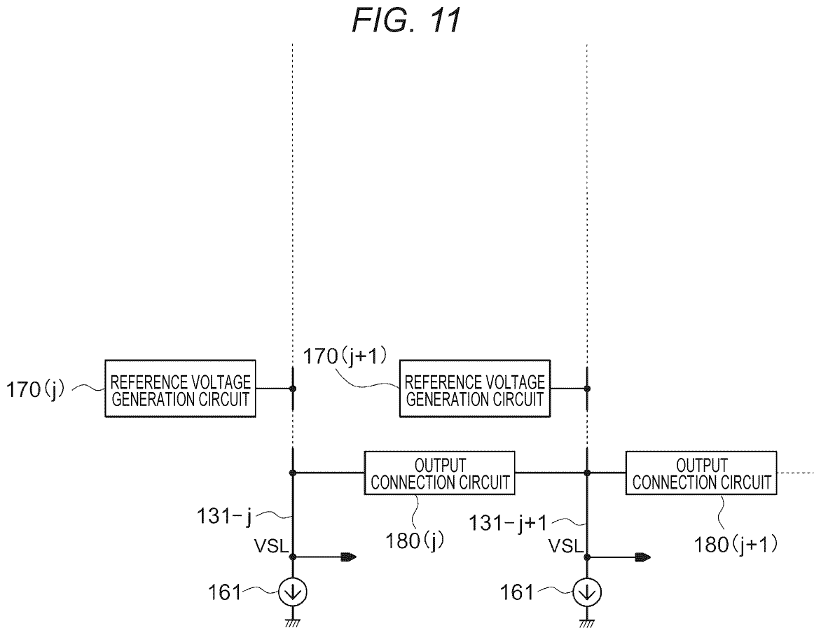

FIG. 11 is a diagram illustrating exemplary configurations of a reference voltage generation circuit 170 and its surroundings according to a fourth embodiment. The third embodiment is different from the first embodiment in the configurations of the surroundings of the reference voltage generation circuit 170. Note that FIG. 11 does not illustrate a pixel 100.

The reference voltage generation circuit 170 is shared among a plurality of pixels 100(i,j) on one pixel column. A plurality of reference voltage generation circuits 170 is provided in accordance with the number of pixel columns.

The plurality of reference voltage generation circuits 170 is electrically connected on a reference voltage output side.

A solid-state imaging device 10 further includes an output connection circuit 180. An output connection circuit 180(j) is, for example, a switch.

A plurality of output connection circuits 180(j) is provided in accordance with the number of pixel columns. The output connection circuit 180(j) is connected between a vertical signal line 131-j and a vertical signal line 131-j+1. Furthermore, the output connection circuit 180(j) is connected to the vertical signal line 131-j on the reference voltage output side of the reference voltage generation circuit 170.

It is possible to reduce the impedance of a reference signal by connecting the vertical signal lines 131 together, using the output connection circuit 180(j). As a result, for example, it is possible to improve a signal transmission speed in the vertical signal line 131.

The configurations of the surroundings of the reference voltage generation circuit 170 may be changed as described in the fourth embodiment. Also in this case, advantageous effects similar to those of the first embodiment can be obtained.

### Fifth Embodiment

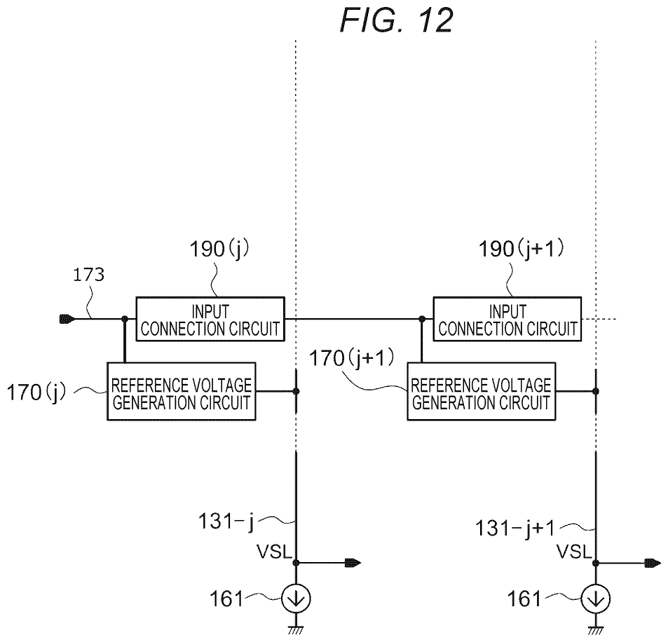

FIG. 12 is a diagram illustrating exemplary configurations of a reference voltage generation circuit 170 and its surroundings according to a fifth embodiment. The third embodiment is different from the first embodiment in the configurations of the surroundings of the reference voltage generation circuit 170.

A plurality of reference voltage generation circuits 170 is electrically connected on a reference voltage input side.

Furthermore, a solid-state imaging device 10 further includes an input wire 173 for connecting the reference voltage generation circuits 170.

The solid-state imaging device 10 further includes an input connection circuit 190. The input connection circuit 190 is, for example, a switch.

A plurality of input connection circuits 190(j) is provided in accordance with the number of pixel columns. The input connection circuit 190(j) is connected between the input wire 173 for inputting a signal to the reference voltage generation circuit 170(j) and the input wire 173 for inputting a signal to the reference voltage generation circuit 170(j+1).

It is possible to reduce the impedance of a reference signal by connecting the input wires 173 together, using the input connection circuit 190(j). As a result, for example, it is possible to improve a signal transmission speed in a vertical signal line 131.

The configurations of the surroundings of the reference voltage generation circuit 170 may be changed as described in the fifth embodiment. Also in this case, advantageous effects similar to those of the first embodiment can be obtained.

### Sixth Embodiment

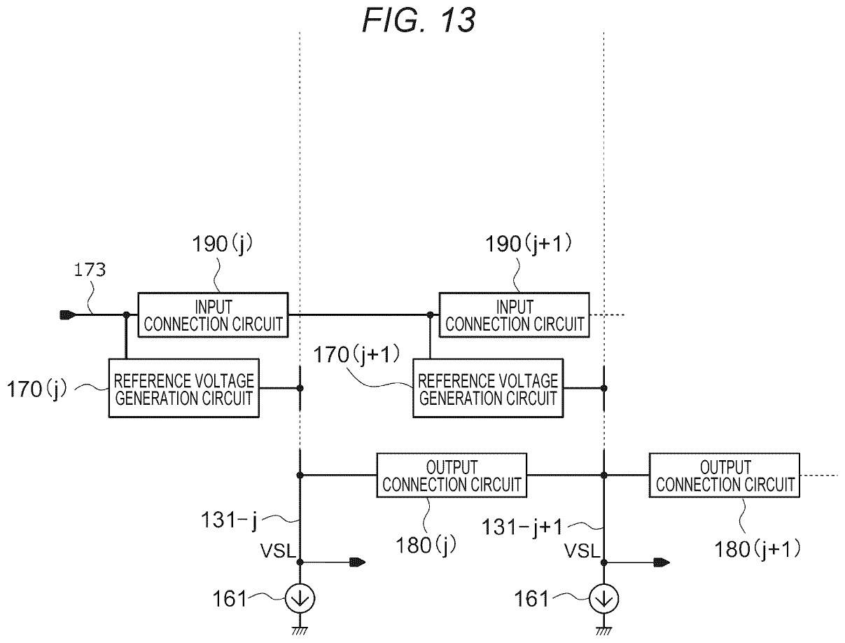

FIG. 13 is a diagram illustrating exemplary configurations of a reference voltage generation circuit and its surroundings according to a sixth embodiment. The third embodiment is different from the first embodiment in the configurations of the surroundings of the reference voltage generation circuit 170.

A plurality of reference voltage generation circuits 170 is electrically connected on a reference voltage input side and a reference voltage output side.

A solid-state imaging device 10 further includes an output connection circuit 180 and an input connection circuit 190. That is, the sixth embodiment is a combination of the fourth embodiment and the fifth embodiment.

It is possible to further reduce the impedance of a reference signal by providing both the output connection circuit 180 and the input connection circuit 190.

Other configurations of a system 1 according to the sixth embodiment may be similar to the corresponding configurations according to the fourth and fifth embodiments.

The configurations of the surroundings of the reference voltage generation circuit 170 may be changed as described in the sixth embodiment. Also in this case, advantageous effects similar to those of the first embodiment can be obtained.

### Seventh Embodiment

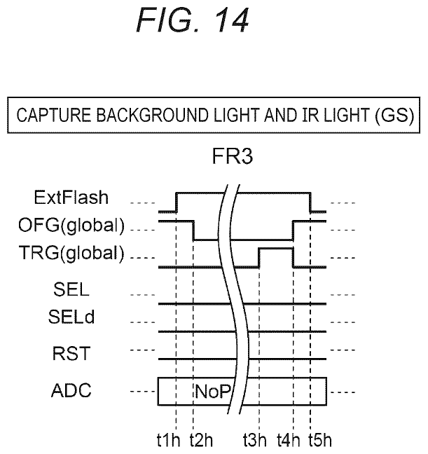

FIG. 14 is a timing chart illustrating exemplary operation of a solid-state imaging device 10 according to a seventh embodiment. The seventh embodiment is different from the first embodiment in a drive timing between a drive signal ExtFlash and a drive signal OFG.

In FIG. 7F according to the first embodiment, the timing when the drive signal ExtFlash becomes high is substantially the same as the timing when the drive signal OFG becomes low (the time t1f). Furthermore, the timing when the drive signal ExtFlash becomes low is substantially the same as the timing when the drive signal OFG becomes high (the time t3f).

However, as illustrated in FIG. 14, the timing when the drive signal ExtFlash becomes high or low may be different from the timing when the drive signal OFG becomes low or high. The timings of the drive signals ExtFlash and OFG are adjusted by, for example, the intensity of a light source 20, the light emission and extinction characteristics of the light source 20, and the like. Furthermore, the drive signal TRG may also be different in timing.

In an initial state, the drive signal ExtFlash is in the Low state. The drive signal OFG is in the High state. Each of drive signals TRG, SEL, SELd, and RST is in a Low state.

First, at a time t1h, the drive signal ExtFlash becomes high. Therefore, the light source 20 emits IR light.

Next, at a time t2h, the drive signal OFG becomes low. Therefore, reset transistors 112 of all pixels 100(i,j) are turned off.

Next, at a time t3h, the drive signal TRG becomes high. Therefore, transfer transistors 121 of all the pixels 100(i,j) are turned on.

Next, at a time t4h, the drive signal TRG becomes low. Therefore, the transfer transistors 121 of all the pixels 100(i,j) are turned off.

Furthermore, at the time t4h, the drive signal OFG becomes high. Therefore, the reset transistors 112 of all the pixels 100(i,j) are turned on. A period from the time t2h to the time t4h is an exposure period.

Next, at a time t5h, the drive signal ExtFlash becomes low. Therefore, the light source 20 stops emitting the IR light.

In the example illustrated in FIG. 14, the drive signal ExtFlash becomes high (the time t1h), and then the drive signal OFG becomes low (the time t2h). In a case where a delay occurs from the time when the drive signal ExtFlash becomes high to the time when the light source 20 emits light, the timing of the drive signal ExtFlash may be adjusted such that the drive signal OFG becomes low at the timing when the light source 20 emits light.

The drive timing between the drive signal ExtFlash and the drive signal OFG may be changed as described in the seventh embodiment. Also in this case, advantageous effects similar to those of the first embodiment can be obtained.

### Eighth Embodiment

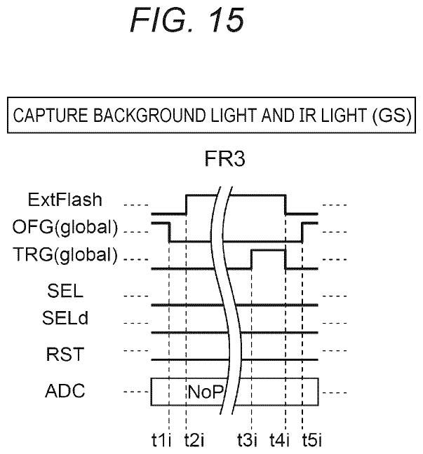

FIG. 15 is a timing chart illustrating exemplary operation of a solid-state imaging device 10 according to an eighth embodiment. The eighth embodiment is different from the seventh embodiment in a drive timing between a drive signal ExtFlash and a drive signal OFG.

In an initial state, the drive signal ExtFlash is in a Low state. The drive signal OFG is in a High state. Each of drive signals TRG, SEL, SELd, and RST is in a Low state.

First, at a time t1i, the drive signal OFG becomes low. Therefore, reset transistors 112 of all pixels 100(i,j) are turned off.

Next, at a time t2i, the drive signal ExtFlash becomes high. Therefore, a light source 20 emits IR light.

Next, at a time t3i, the drive signal TRG becomes high. Therefore, transfer transistors 121 of all the pixels 100(i,j) are turned on.

Next, at a time t4i, the drive signal TRG becomes low. Therefore, the transfer transistors 121 of all the pixels 100(i,j) are turned off.

Furthermore, at the time t4i, the drive signal ExtFlash becomes low. Therefore, the light source 20 stops emitting the IR light.

Next, at a time t5i, the drive signal OFG becomes high. Therefore, the reset transistors 112 of all the pixels 100(i,j) are turned on. A period from the time t1i to the time t4i is an exposure period.

The drive timing between the drive signal ExtFlash and the drive signal OFG may be changed as described in the eighth embodiment. Also in this case, advantageous effects similar to those of the seventh embodiment can be obtained.

### Ninth Embodiment

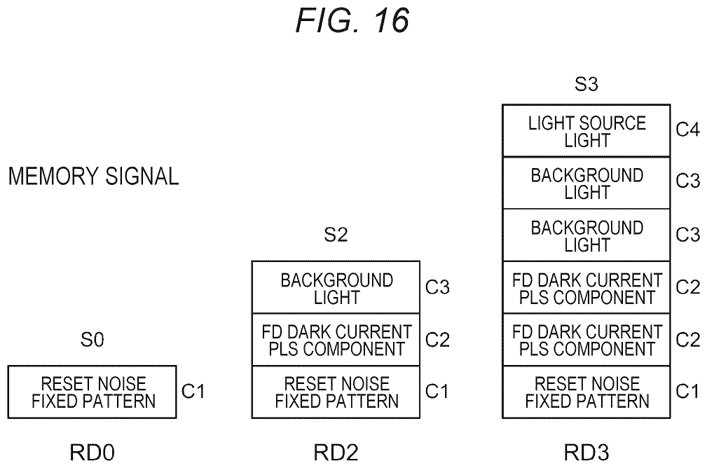

FIG. 16 is a diagram illustrating exemplary signal components in reads RD0, RD2, and RD3 according to a ninth embodiment. The ninth embodiment is different from the first embodiment in a respect that the operations in the first frame FR1 and read RD1 among the operations illustrated in FIG. 5 are not performed.

After a reset (RST), a solid-state imaging device 10 performs a sequence operation in the order of the read RD0, a second frame FR2, the read RD2, a third frame FR3, and the read RD3.

A pixel signal S0 read by the read RD0 is represented by Equation 1 as in the first embodiment described with reference to FIG. 6.

As illustrated in FIG. 16, a pixel signal S2 read by the read RD2 is represented by Equation 5 using a signal component C1, a signal component C2, and a signal component C3.

$$S 2 = C 1 + C 2 + C 3 \qquad ( Equation 5 )$$

Since the first frame FR1 and the read RD1 are not performed, the pixel signal S2 according to the second embodiment is lower by the signal component C2 than the pixel signal S2 according to the first embodiment (see Equation 3 and FIG. 6).

As illustrated in FIG. 16, a pixel signal S3 read by the read RD3 is represented by Equation 6 using the signal component C1, the signal component C2, the signal component C3, and a signal component C4.

$$S 3 = C 1 + 2 \times C 2 + 2 \times C 3 + C 4 \qquad ( Equation 6 )$$

Since the first frame FR1 and the read RD1 are not performed, the pixel signal S3 according to the second embodiment is lower by the signal component C2 than the pixel signal S3 according to the first embodiment (see Equation 4 and FIG. 6).

The calculation part 43 illustrated FIG. 1 calculates a sum of the signal components C2 and C3 (S2−S0=C2+C3) on the basis of Equation 1 and Equation 5. The calculation part 43 calculates the signal component C4 (S3−S0−2×(C2+C3)=C4) on the basis of Equation 1, Equation 6, and the sum of the signal components C2 and C3. Therefore, it is possible to calculate the signal component C4 of light source light. Accordingly, in a case where it is unnecessary to individually obtain the signal component C3 of the background light, it is possible to obtain the signal component C4 of the light source light from the calculation described above.

Note that the solid-state imaging device 10 may read an image (a CDS image) by a rolling shutter operation after the sequence operation described above, that is, after the read RD3, or the like. This image read is performed by, for example, a read method of a typical CMOS image sensor. Therefore, even in a case where the operations in the first frame FR1 and read RD1 are not performed, it is possible to obtain the signal component C3 of the background light.

The first frame FR1 and the read RDI are not necessarily performed as described in the ninth embodiment. Also in this case, advantageous effects similar to those of the first embodiment can be obtained.

### Tenth Embodiment

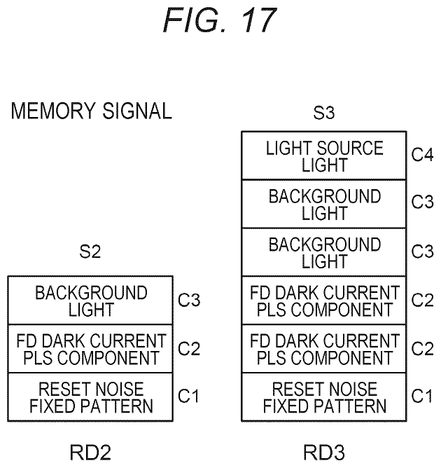

FIG. 17 is a diagram illustrating exemplary signal components in reads RD2 and RD3 according to a tenth embodiment. The tenth embodiment is different from the ninth embodiment in a respect that the read RD0 is not further performed. Accordingly, according to the tenth embodiment, the operations in the read RD0, first frame FR1, and read RD1 among the operations illustrated in FIG. 5 are not performed.

After a reset (RST), a solid-state imaging device 10 performs a sequence operation in the order of a second frame FR2, the read RD2, a third frame FR3, and the read RD3.

A pixel signal S2 read by the read RD2 is represented by Equation 5 as in the ninth embodiment described with reference to FIG. 16.

A pixel signal S3 read by the read RD3 is represented by Equation 6 as in the ninth embodiment described with reference to FIG. 16.

According to the tenth embodiment, the read RD0 is not performed. However, in a case where a signal component C1 is sufficiently smaller than signal components C2 and C3, it is possible to ignore the signal component C1. It is possible to suppress reset noise (kTC noise) in the signal component C1 to a negligible extent by sufficiently increasing an in-pixel capacitance, for example. Furthermore, a gain control transistor 127 may be in an ON state at the time when a charge in a floating diffusion 126 is reset. Therefore, it is possible to electrically connect the floating diffusion 126 to a capacitor C and to increase an in-pixel capacitance.

A calculation part 43 calculates a signal component C4 (S3−2×S2=C4) on the basis of pixel signals S2 and S3, by ignoring the signal component C1.

The read RD0 is not necessarily further performed as described in the tenth embodiment. Also in this case, advantageous effects similar to those of the ninth embodiment can be obtained.

### Eleventh Embodiment

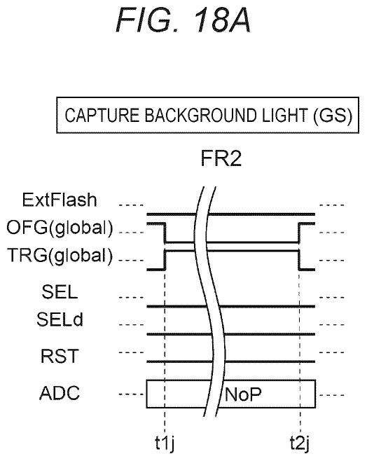

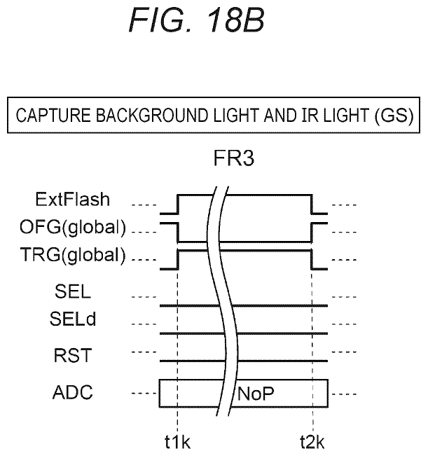

FIGS. 18A and 18B are timing charts each illustrating exemplary operation of a solid-state imaging device 10 according to an eleventh embodiment. FIG. 18A illustrates an operation in a second frame FR2, and FIG. 18B illustrates an operation in a third frame FR3. The eleventh embodiment is different from the first embodiment in a respect that a transfer transistor 121 operates exclusively with a reset transistor 112.

In the example illustrated in FIG. 18A, a timing when a drive signal TRG becomes high is substantially the same as a timing when a drive signal OFG becomes low. Therefore, in the second frame FR2, it is possible to accumulate a charge in an in-pixel capacitance in addition to a photodiode 111. As a result, it is possible to accumulate a charge greater than or equal to the capacitance of the photodiode 111 and to expand a dynamic range. The in-pixel capacitance includes, for example, a floating diffusion 126 and a capacitor C.

In an initial state, a drive signal ExtFlash is in a Low state. The drive signal OFG is in a High state. Each of drive signals TRG, SEL, SELd, and RST is in a Low state.

First, at a time t1j, the drive signal OFG becomes low. Therefore, reset transistors 112 of all pixels 100(i,j) are turned off.

Furthermore, at the time t1j, the drive signal TRG becomes high. Therefore, the transfer transistors 121 of all the pixels 100(i,j) are turned on.

Next, at a time t2j, the drive signal OFG becomes high. Therefore, the reset transistors 112 of all the pixels 100(i,j) are turned on. A period from the time t1j to the time t2j is an exposure period.

Furthermore, at the time t2j, the drive signal TRG becomes Therefore, the transfer transistors 121 of all the pixels low. 100(i,j) are turned off.

In the example illustrated in FIG. 18B, the timing when the drive signal TRG becomes high is substantially the same as the timing when the drive signal OFG becomes low. Therefore, in the third frame FR3, it is possible to accumulate the charge in the in-pixel capacitance in addition to the photodiode 111. As a result, it is possible to accumulate a charge greater than or equal to the capacitance of the photodiode 111 and to expand the dynamic range. The in-pixel capacitance includes, for example, the floating diffusion 126 and the capacitor C.

In the initial state, the drive signal ExtFlash is in the Low state. The drive signal OFG is in the High state. Each of the drive signals TRG, SEL, SELd, and RST is in the Low state.

First, at a time t1k, the drive signal OFG becomes low. Therefore, the reset transistors 112 of the all pixels 100(i,j) are turned off.

Furthermore, at the time t1k, the drive signal ExtFlash becomes high. Therefore, a light source 20 emits IR light.

Furthermore, at the time t1k, the drive signal TRG becomes high. Therefore, the transfer transistors 121 of all the pixels 100(i,j) are turned on.

Next, at a time t2k, the drive signal OFG becomes high. Therefore, the reset transistors 112 of all the pixels 100(i,j) are turned on. A period from the time t1k to the time t2k is an exposure period.

Furthermore, at the time t2k, the drive signal TRG becomes low. Therefore, the transfer transistors 121 of all the pixels 100(i,j) are turned off.

Furthermore, at the time t2k, the drive signal ExtFlash becomes low. Therefore, the light source 20 stops emitting the IR light.

The transfer transistor 121 may operate exclusively with the reset transistor 112 as described in the eleventh embodiment. Also in this case, advantageous effects similar to those of the first embodiment can be obtained.

### Twelfth Embodiment

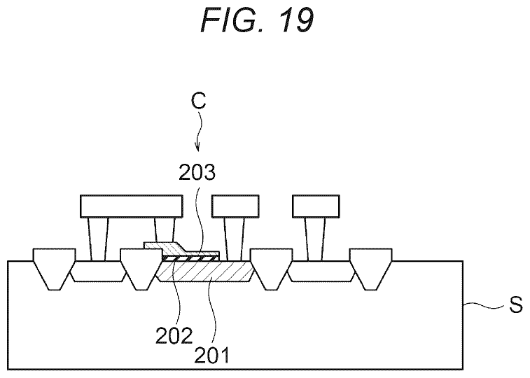

FIG. 19 is a sectional view illustrating an exemplary configuration of a solid-state imaging device 10 according to a twelfth embodiment. FIG. 19 illustrates a peripheral configuration of the capacitor C illustrated in FIG. 3. In the twelfth embodiment, an example of the configuration of the capacitor C illustrated in FIG. 3 is described.

The solid-state imaging device 10 further includes a semiconductor substrate S where at least a part of each pixel 100 is provided. The semiconductor substrate S is, for example, a silicon substrate.

The capacitor C illustrated in FIG. 19 is a MOS capacitor of a planar type. The capacitor C includes a semiconductor layer 201, an insulating layer 202, and a metal layer 203. The semiconductor layer 201 and the metal layer 203 respectively correspond to a lower electrode and an upper electrode of the capacitor C.

The semiconductor layer 201 is provided in the semiconductor substrate S along a surface of the semiconductor substrate S. The semiconductor layer 201 is a diffusion layer containing impurities.

The insulating layer 202 is provided on the semiconductor layer 201. The insulating layer 202 is provided between the semiconductor layer 201 and the metal layer 203. The insulating layer 202 contains, for example, SiO₂. Note that the insulating layer 202 may contain SiN, SiON, or the like.

The metal layer 203 is provided on the insulating layer 202. The metal layer 203 contains, for example, polysilicon. Note that the metal layer 203 may contain tungsten (W) or the like.

Furthermore, the metal layer 203 is preferably on a signal charge accumulation side. Therefore, it is possible to suppress a leak current at a pn junction.

The capacitor C may be a MOS capacitor of a planar type as described in the twelfth embodiment. Also in this case, advantageous effects similar to those of the first embodiment can be obtained.

### Thirteenth Embodiment

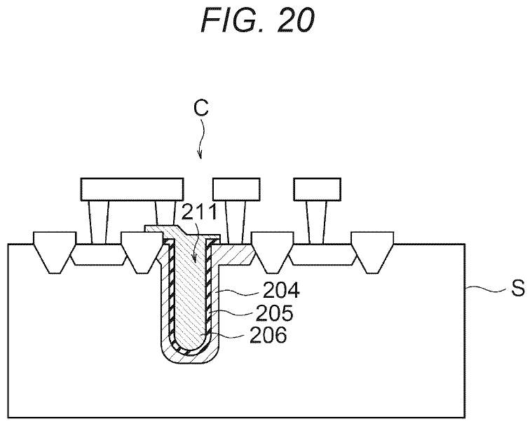

FIG. 20 is a sectional view illustrating an exemplary configuration of a solid-state imaging device 10 according to a thirteenth embodiment. FIG. 20 illustrates a peripheral configuration of the capacitor C illustrates in FIG. 3. In the thirteenth embodiment, an example of the configuration of the capacitor C illustrated in FIG. 3 is described.

The solid-state imaging device 10 further includes a semiconductor substrate S where at least a part of each pixel 100 is provided. The semiconductor substrate S has a recessed portion (a recess) 211 carved in a surface. The semiconductor substrate S is, for example, a silicon substrate.

The capacitor C illustrated in FIG. 20 is a MOS capacitor of a trench type. The recessed portion 211 can further increase an area of the capacitor C and can further increase an electrostatic capacitance of the capacitor C. The capacitor C includes a semiconductor layer 204, an insulating layer 205, and a metal layer 206. The semiconductor layer 204 and the metal layer 206 respectively correspond to a lower electrode and an upper electrode of the capacitor C.

The semiconductor layer 204 is provided in the semiconductor substrate S along the surface of the semiconductor substrate S and the recessed portion 211. The semiconductor layer 204 is a diffusion layer containing impurities.

The insulating layer 205 is provided on the semiconductor layer 204. The insulating layer 205 is provided between the semiconductor layer 204 and the metal layer 206. The insulating layer 205 is provided along the recessed portion 211. The material for the insulating layer 205 is the same as, for example, the material for the insulating layer 202 illustrated in FIG. 19.

The metal layer 206 is provided on the insulating layer 205. The metal layer 206 is provided to be embedded in the recessed portion 211. The material for the metal layer 206 is the same as, for example, the material for the metal layer 203 illustrated in FIG. 19.

Furthermore, the metal layer 206 is preferably on a signal charge accumulation side. Therefore, it is possible to suppress a leak current at a pn junction.

The capacitor C may be a MOS capacitor of a trench type as described in the thirteenth embodiment. Also in this case, advantageous effects similar to those of the first embodiment can be obtained.

### Fourteenth Embodiment

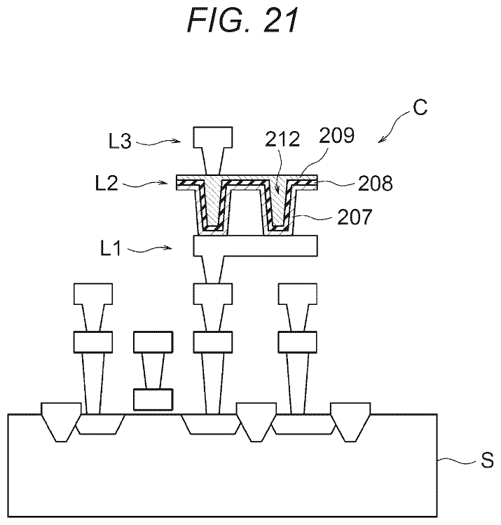

FIG. 21 is a sectional view illustrating an exemplary configuration of a solid-state imaging device 10 according to a fourteenth embodiment. FIG. 21 illustrates a peripheral configuration of the capacitor C illustrated in FIG. 3. In the fourteenth embodiment, an example of the configuration of the capacitor C illustrated in FIG. 3 is described.

The solid-state imaging device 10 further includes a semiconductor substrate S where at least a part of each pixel 100 is provided, and a plurality of wiring layers L1 to L3. The semiconductor substrate S is, for example, a silicon substrate. The plurality of wiring layers L1 to L3 is provided above the semiconductor substrate S.

A recessed portion (a recess) 212 that passes from the wiring layer L2 to the wiring layer L1 is provided in an interlayer insulating film (not illustrated) between the wiring layer L1 and the wiring layer L2.

The capacitor C illustrated in FIG. 21 is a metal-insulator-metal (MIM) capacitor formed on a wiring layer (e.g., the wiring layer L2). The capacitor C includes a metal layer 207, an insulating layer 208, and a metal layer 209. The metal layer 207 and the metal layer 209 respectively correspond to a lower electrode and an upper electrode of the capacitor C.

The metal layer 207 is provided on a bottom portion of the wiring layer L2. The metal layer 207 is provided along the recessed portion 212. The metal layer 207 contains Ti/TiN, Ta, or the like.

The insulating layer 208 is provided on the metal layer 207. The insulating layer 208 is provided between the metal layer 207 and the metal layer 209. The insulating layer 208 is provided along the recessed portion 212. The insulating layer 208 is, for example, a high dielectric constant (High-k) insulating film. The insulating layer 208 contains SiN, SiON, HfO, AlO, Zro, or the like.

The metal layer 209 is provided on the insulating layer 208. The metal layer 209 is provided on an upper portion of the wiring layer L2. The metal layer 209 is provided to be embedded in the recessed portion 212. The material for the metal layer 209 is the same as, for example, the material for the metal layer 207.

The capacitor C may be a MIM capacitor as described in the fourteenth embodiment. Also in this case, advantageous effects similar to those of the first embodiment can be obtained.

### Application Example to Mobile Body

The technology according to the present disclosure (the present technology) is applicable to various products. For example, the technology according to the present disclosure may be implemented in the form of a device to be mounted on a mobile object of any kind, such as an automobile, an electric vehicle, a hybrid electric vehicle, a motorcycle, a bicycle, a personal mobility, an airplane, a drone, a vessel, a robot, or the like.

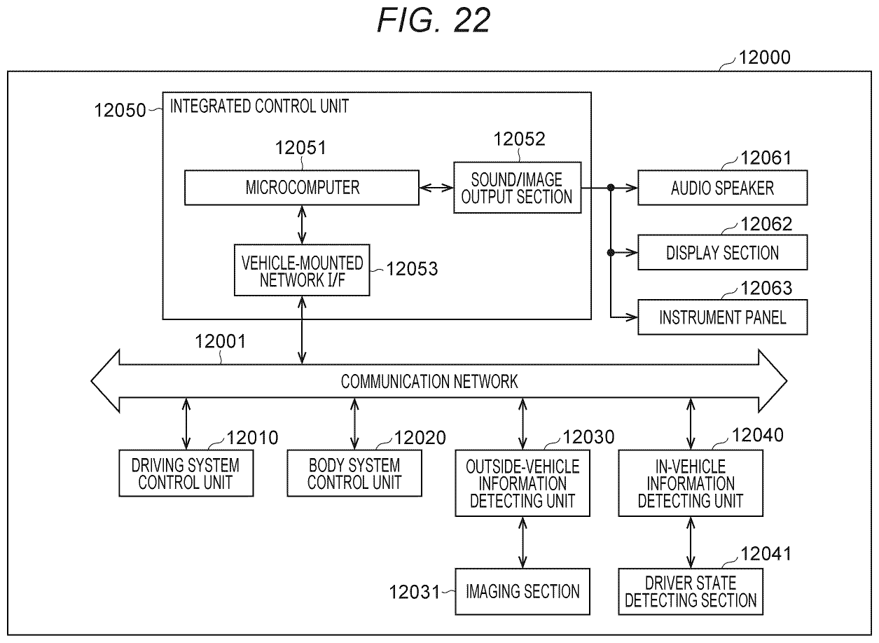

FIG. 22 is a block diagram illustrating an exemplary schematic configuration of a vehicle control system as an example of a mobile body control system to which the technology according to the present disclosure is applicable.

The vehicle control system 12000 includes a plurality of electronic control units connected to each other via a communication network 12001. In the example depicted in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12030 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 22, an audio speaker 12061, a display section 12062, and an instrument panel 12063 are illustrated as the output device. The display section 12062 may, for example, include at least one of an on-board display and a head-up display.

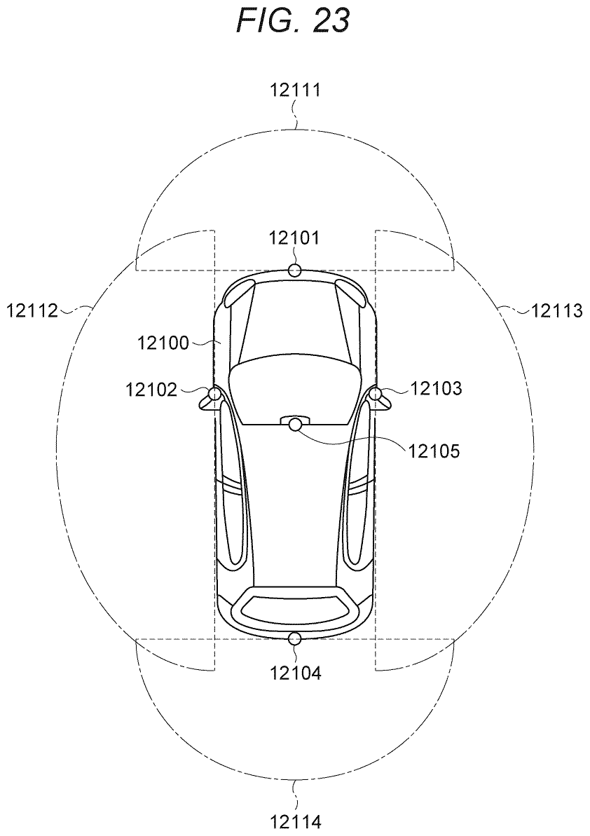

FIG. 23 is a diagram illustrating an exemplary installation position of the imaging section 12031.

In FIG. 23, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 23 illustrates exemplary imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to, for example, the imaging sections 12031, 12101, 12102, 12103, 12104, 12105, and the like among the above-described configurations. Specifically, for example, the system 1 in FIG. 1 is applicable to these imaging sections. By applying the technology according to the present disclosure to these imaging sections, it is possible to obtain a high-definition captured image with less noise; therefore, it is possible to perform high-accuracy control using the imaged image in a mobile body control system.

Note that the present technology may have the following configurations.
(1)

A system including:
a light source that emits light to a subject;
a photodetection element that receives the light from the light source; and
a light source control part that controls a light emission timing of the light source,
in which
the photodetection element includes:
   a photoelectric conversion part that generates by photoelectric conversion a charge pursuant to an amount of the received light;
   a transfer part that transfers the charge generated by the photoelectric conversion part; and
   a charge accumulation part that accumulates the charge transferred by the transfer part, and
the charge accumulated in the charge accumulation part is read at least twice or more nondestructively without being initialized, over a plurality of frames.
(2)

The system as recited in (1), in which
the photodetection element further includes a first initialization part that initializes a charge in the photoelectric conversion part, and
a plurality of the first initialization parts of all pixels each stop initializing a charge in a corresponding one of a plurality of the photoelectric conversion parts of all the pixels in a predetermined period, so that the photoelectric conversion parts substantially concurrently accumulate charges.
(3)

The system as recited in (2), in which
the light source control part controls the light emission timing of the light source such that the light source emits the light in the predetermined period.
(4)

The system as recited in (2) or (3), in which
a plurality of the transfer parts each transfer the charge accumulated in a corresponding one of the plurality of the photoelectric conversion parts to a corresponding one of a plurality of the charge accumulation parts in the predetermined period.
(5)

The system as recited in any one of (1) to (4), in which
the photodetection element further includes a read part that reads the charge accumulated in the charge accumulation part, and
the read part reads the charge accumulated in the charge accumulation part, nondestructively without initialization for every single pixel or a plurality of the read parts respectively read charges accumulated in a plurality of the charge accumulation parts, nondestructively without initialization for every multiple pixels.
(6)

The system as recited in any one of (1) to (5), in which
the photodetection element further includes a second initialization part that initializes the charge accumulated in the charge accumulation part over the plurality of frames.
(7)

The system as recited in (6), in which
in a plurality of pixels, a plurality of the second initialization parts each initialize a charge in a corresponding one of a plurality of the charge accumulation parts such that the charges are accumulated in the charge accumulation parts for substantially a same period of time.
(8)

The system as recited in (6) or (7), in which
in a case where the charge accumulated in the charge accumulation part is read nondestructively without being initialized for every single pixel, the second initialization part initializes the charge in the charge accumulation part for every single pixel, and
in a case where charges accumulated in a plurality of the charge accumulation parts are read nondestructively without being initialized for every multiple pixels, a plurality of the second initialization parts each initialize the charge in a corresponding one of the plurality of the charge accumulation parts for every multiple pixels.
(9)

The system as recited in any one of (1) to (8), in which
the charge accumulated in the charge accumulation part is read four times over the plurality of frames,
a first read is performed during initialization of the charge in the charge accumulation part or after the initialization of the charge in the charge accumulation part,
a second read after the first read is performed after a first frame in which no charge is accumulated in the photoelectric conversion part,
a third read after the second read is performed after a second frame in which a charge is accumulated in the photoelectric conversion part and the light source emits no light, and
a fourth read after the third read is performed after a third frame in which a charge is accumulated in the photoelectric conversion part and the light source emits light.
(10)

The system as recited in (9), further including
a calculation part that calculates at least one of a signal component of the light emitted from the light source or a signal component of background light, on the basis of signals pursuant to the charges respectively read by the first read, the second read, the third read, and the fourth read.
(11)

The system as recited in any one of (1) to (10), in which
the photodetection element further includes a reference voltage generation part that generates a reference voltage for a read part that reads the charge accumulated in the charge accumulation part, before the read part reads the charge.
(12)

The system as recited in (11), in which
the photodetection element further includes a pixel array part including a plurality of pixels that are arranged, and
the reference voltage generation part includes a dummy pixel that is provided in the pixel array part.
(13)

The system as recited in (11), in which
the reference voltage generation part includes a reference voltage node to which the reference voltage is supplied.
(14)

The system as recited in any one of (11) to (13), including
a plurality of the reference voltage generation parts shared among a plurality of pixels,
the plurality of the reference voltage generation parts being electrically connected on at least one of an input side of the reference voltage or an output side of the reference voltage.
(15)

The system as recited in any one of (1) to (14), in which
the photodetection element further includes:
an additional capacitance part that adds a capacitance to the charge accumulation part; and
a switch part that switches addition of the capacitance by the additional capacitance part.
(16)

The system as recited in any one of (1) to (15), in which
the light source emits infrared (IR) light.

Aspects of the present disclosure are not limited to the above-described individual embodiments, but include various modifications that can be conceived by those skilled in the art. The advantageous effects of the present disclosure are not limited to the above-described contents. That is, various additions, modifications, and partial deletions can be made without departing from the conceptual idea and spirit of the present disclosure derived from the matters defined in the claims and equivalents thereof.

### REFERENCE SIGNS LIST

1 System
10 Solid-state imaging device
20 Light source
30 Storage part
40 Control part
42 Light source control part
43 Calculation part
100 Pixel, Dummy pixel 100d
111 Photodiode
112 Reset transistor
121 Transfer transistor
123 Reset transistor
126 Floating diffusion
127 Gain control transistor
170 Reference voltage generation circuit
171 Transistor
172 Transistor
180 Output connection circuit
190 Input connection circuit
FR1 to FR3 Frame
RD0 to RD3 Read
T1 Predetermined period
T2 Predetermined period

1. A system comprising:
a light source that emits light to a subject;
a photodetection element that receives the light from the light source; and
a light source control part that controls a light emission timing of the light source,
wherein
the photodetection element includes:
a photoelectric conversion part that generates by photoelectric conversion a charge pursuant to an amount of the received light;
a transfer part that transfers the charge generated by the photoelectric conversion part; and
a charge accumulation part that accumulates the charge transferred by the transfer part, and
the charge accumulated in the charge accumulation part is read at least twice or more nondestructively without being initialized, over a plurality of frames.

2. The system according to claim 1, wherein
the photodetection element further includes a first initialization part that initializes a charge in the photoelectric conversion part, and
a plurality of the first initialization parts of all pixels each stop initializing a charge in a corresponding one of a plurality of the photoelectric conversion parts of all the pixels in a predetermined period, so that the photoelectric conversion parts substantially concurrently accumulate charges.

3. The system according to claim 2, wherein
the light source control part controls the light emission timing of the light source such that the light source emits the light in the predetermined period.

4. The system according to claim 2, wherein
a plurality of the transfer parts each transfer the charge accumulated in a corresponding one of the plurality of the photoelectric conversion parts to a corresponding one of a plurality of the charge accumulation parts in the predetermined period.

5. The system according to claim 1, wherein
the photodetection element further includes a read part that reads the charge accumulated in the charge accumulation part, and
the read part reads the charge accumulated in the charge accumulation part, nondestructively without initialization for every single pixel or a plurality of the read parts respectively read charges accumulated in a plurality of the charge accumulation parts, nondestructively without initialization for every multiple pixels.

6. The system according to claim 1, wherein
the photodetection element further includes a second initialization part that initializes the charge accumulated in the charge accumulation part over the plurality of frames.

7. The system according to claim 6, wherein
in a plurality of pixels, a plurality of the second initialization parts each initialize a charge in a corresponding one of a plurality of the charge accumulation parts such that the charges are accumulated in the charge accumulation parts for substantially a same period of time.

8. The system according to claim 6, wherein
in a case where the charge accumulated in the charge accumulation part is read nondestructively without being initialized for every single pixel, the second initialization part initializes the charge in the charge accumulation part for every single pixel, and
in a case where charges accumulated in a plurality of the charge accumulation parts are read nondestructively without being initialized for every multiple pixels, a plurality of the second initialization parts each initialize the charge in a corresponding one of the plurality of the charge accumulation parts for every multiple pixels.

9. The system according to claim 1, wherein
the charge accumulated in the charge accumulation part is read four times over the plurality of frames,
a first read is performed during initialization of the charge in the charge accumulation part or after the initialization of the charge in the charge accumulation part,
a second read after the first read is performed after a first frame in which no charge is accumulated in the photoelectric conversion part,
a third read after the second read is performed after a second frame in which a charge is accumulated in the photoelectric conversion part and the light source emits no light, and
a fourth read after the third read is performed after a third frame in which a charge is accumulated in the photoelectric conversion part and the light source emits light.

10. The system according to claim 9, further comprising
a calculation part that calculates at least one of a signal component of the light emitted from the light source or a signal component of background light, on a basis of signals pursuant to the charges respectively read by the first read, the second read, the third read, and the fourth read.

11. The system according to claim 1, wherein
the photodetection element further includes a reference voltage generation part that generates a reference voltage for a read part that reads the charge accumulated in the charge accumulation part, before the read part reads the charge.

12. The system according to claim 11, wherein
the photodetection element further includes a pixel array part including a plurality of pixels that are arranged, and
the reference voltage generation part includes a dummy pixel that is provided in the pixel array part.

13. The system according to claim 11, wherein
the reference voltage generation part includes a reference voltage node to which the reference voltage is supplied.

14. The system according to claim 11, comprising
a plurality of the reference voltage generation parts shared among a plurality of pixels,
the plurality of the reference voltage generation parts being electrically connected on at least one of an input side of the reference voltage or an output side of the reference voltage.

15. The system according to claim 1, wherein
the photodetection element further includes:
an additional capacitance part that adds a capacitance to the charge accumulation part; and
a switch part that switches addition of the capacitance by the additional capacitance part.

16. The system according to claim 1, wherein
the light source emits infrared (IR) light.
